(19) United States
(12) Patent Application Publication
(10) Pub. No.: US 2022/0144219 A1
(43) Pub. Date: May 12, 2022

(54) SELF-CONTAINED MOTOR VEHICLE CAMERA CLEANING SYSTEM

(71) Applicant: Camera Cleaning Innovations, LLC, Hebron, CT (US)

(72) Inventor: Carmen John D'Onofrio, Hebron, CT (US)

(21) Appl. No.: 17/438,486

(22) PCT Filed: Jul. 20, 2020
(86) PCT No.: PCT/US2020/042777

§ 371 Date: Sep. 13, 2021

Related U.S. Application Data
(60) Provisional application No. 62/875,908, filed on Jul. 18, 2019.

(51) Int. Cl. B60S 1/56; B60S 1/50; B60S 1/52

(52) U.S. Cl. CPC B60S 1/56; B60R 13/105; B60S 1/52; B60S 1/50

(57) ABSTRACT

A self-contained system may be used for the cleaning of a lens of a camera or image sensor of a motor vehicle, the lens cleaning system has a frame that is configured to be mounted to an exterior surface of the motor vehicle and may also be configured for seating a vehicle license plate, the system has a nozzle to direct wash fluid to the camera lens, wherein the aim of the nozzle is adjustable to accommodate various camera positions, the system has a fluid container that, in operation is not pressurized and is refillable, and a pump configured to transfer fluid from the fluid container to the nozzle, the system also has a controller to operate the pump, the controller may be selectively activated by a receiver that is configured to receive a remotely generated signal from a transmitter, or may be automatically activated by a sensor.

### CROSS-REFERENCE TO RELATED APPLICATIONS

This application is a National Stage of International Application No. PCT/US2020/042777, filed Jul. 20, 2020, which claims priority to U.S. Provisional Application No. 62/875,908, filed Jul. 18, 2019, the disclosures of which are incorporated herein by reference in their entirety.

### TECHNICAL FIELD

The disclosed embodiments relate to an automobile system and more specifically to a self-contained motor vehicle camera cleaning system.

### BACKGROUND

Motor vehicle (“vehicle”) rear-view cameras, which improve rearward visibility, represent a safety improvement in the automotive industry. Using an interior video display screen (for example, dashboard mounted), the vehicle operator may be able to see obstacles that are close to the vehicle, which otherwise may be hidden from view. Also, vehicle camera systems may provide assistance in rearward navigation by displaying vehicle proximity to nearby objects, and in some vehicles, a trajectory zone using data from the vehicle's steering system to alert the operator to objects that may reside within the operator's intended path.

There is a worldwide utilization of automotive camera technology. This is the result of consumer demand for improved vehicle safety and ease of vehicle operation, as well as new laws intended to reduce pedestrian injuries and fatalities.

However, the current motor vehicle camera technology may be less reliable when operating in adverse weather or dirty driving conditions. A camera may become less effective when the lens is covered in ice, salt or dirt. Water droplets that may reside on the exterior surface of the camera lens may also impair the operator's ability to view people or objects located behind the vehicle.

Motor vehicle camera systems, which are intended to improve automotive safety and operator convenience, may not consistently provide clear rearward visibility due to such foreign matter accumulation. An operator may become aware of a rearward visibility issue only when he or she is already in the driver's seat and shifts the motor vehicle into reverse. Instead of viewing a clear rear image on the interior video display screen of the motor vehicle, the operator may be presented with a cloudy, impaired image that may be unsuitable to safely provide the expected assistance.

Factory-installed integrated automotive camera wash systems, which may offer an immediate camera lens cleaning capability to the operator, have not been incorporated into all motor vehicles equipped with rear-view cameras. Automotive manufacturers may advise operators to manually clean a camera lens using a cleaning solution and a soft cloth on a periodic basis, which may be inconvenient for the operator. As a result, an operator may fail to clean a camera lens when the rear view becomes impaired by foreign matter accumulation on the lens. In such situations, an operator may attempt to navigate a backup using an impaired video image. This may create a safety hazard by increasing the risk of collision with a nearby vehicle or pedestrian.

The growing dependency of motor vehicle operators on rear-view cameras, which may be unable to deliver a clear rear view, may represent an increasing liability for both operators and pedestrians.

There is a wide variety of vehicle designs, body shapes and styles in the marketplace today. A rear-view camera may be installed in an inconspicuous location on a vehicle, such as somewhere above the license plate or near the release mechanism for the lift-gate, trunk or tail-gate. The specific position, shape, and size of a camera body may vary significantly from one vehicle model to the next.

The above factors may present a challenge for the creation of an effective camera cleaning system that can be retrofitted to a wide variety of motor vehicle models. In addition, vehicle owners may be technically incapable of retrofitting their vehicles with such systems, or reluctant to make permanent alterations to their vehicles, such as drilling holes into body panels that may be visible after removing such systems.

Thus, there is a need for an effective camera cleaning system that is readily adaptable to multiple motor vehicle models, and can be installed onto a vehicle without the need for special skills, expertise, or complex modifications to the vehicle.

### SUMMARY OF THE DISCLOSED EMBODIMENTS

An embodiment of the system for cleaning a lens of a camera or image sensor may include a frame configured to be mounted to an exterior surface of a motor vehicle, a nozzle secured to the frame and configured to direct fluid to the lens for cleaning the lens, wherein the aim of the nozzle is adjustable, a pump secured to the frame and connected to the nozzle to direct fluid to the nozzle, a fluid container secured to, or integrated with, the frame, and connected to the pump, wherein the fluid container includes a container wall defining an internal chamber and an aperture that exposes the internal chamber to atmospheric pressure so that, in operation, the internal chamber is configured to remain unpressurized, and wherein the pump is configured to transfer fluid from the fluid container to the nozzle, and a controller configured for electrical connection to the pump wherein the controller transfers power to operate the pump in response to reception of a control signal by the controller.

An embodiment of the system may include a nozzle that is configured to direct a substantially solid stream of fluid to the lens.

An embodiment of the system may include a power supply that is secured to the frame and connected to the controller, wherein the controller transfers power to the pump that is configured to transfer fluid from the fluid container to the nozzle.

An embodiment of the system may include a receiver that is connected to, or integrated with, the controller, wherein the receiver is configured to receive a remotely generated signal and relay a control signal to the controller which transfers power to the pump, whereby the pump transfers fluid from the fluid container to the nozzle.

An embodiment of the system may include a transmitter that is selectively actuable to transmit the remotely generated signal for reception by the receiver.

An embodiment of the system may include a sensor that is connected to, or integrated with, the controller, and wherein the sensor is configured to automatically relay a control signal to the controller upon sensing predefined conditions, whereby the controller transfers power to the pump that transfers fluid from the fluid container to the nozzle.

An embodiment of the system may be configured wherein the frame includes a back surface that is configured for being mounted to the vehicle, the frame includes support features extending away from the back surface and including seating surfaces for positioning a license plate, the frame is configured for seating the license plate, offset from the back surface, to create a storage volume, the storage volume being the volume of space between the back surface of the frame and the license plate when the license plate is secured to the frame, and one or more of the fluid container, the controller, and the pump are disposed within the storage volume of the frame.

An embodiment of the system may include a frame including a back surface that is configured for being mounted to a motor vehicle, wherein the frame includes a seating surface defining a first area, the first area including a top end and an opposing bottom end, the seating surface in the first area of the frame being configured for seating a license plate and displaying license plate indicia so that the indicia is displayed between the top end of the first area and the bottom end of the first area, and a nozzle mounted proximate the bottom end of the first area, and configured to direct fluid upwardly to engage the lens for cleaning the lens, wherein the aim of the nozzle is adjustable.

An embodiment of the system may include a nozzle configured to direct a substantially solid stream of wash fluid to the lens.

An embodiment of the system may include a bracket that is mounted to the frame and supports the nozzle proximate the bottom end of the first area of the frame.

An embodiment of the system may include a fluid container secured to, or integrated with, the frame, and connected to the pump, wherein the fluid container includes a container wall defining an internal chamber and an aperture that exposes the internal chamber to atmospheric pressure so that, in operation, the internal chamber is configured to remain unpressurized, and wherein the pump is configured to transfer fluid from the fluid container to the nozzle.

An embodiment of the system may include a pump that is secured to the frame, the pump connected to the fluid container and configured to pressurize the fluid, whereby the fluid is transferred to the nozzle.

An embodiment of the system may include a controller that is configured for electrical connection to the pump wherein the controller transfers power to operate the pump in response to reception of a control signal by the controller.

An embodiment of the system may include a power supply that is secured to the frame and connected to the controller, wherein the controller transfers power to the pump that is configured to transfer fluid from the fluid container to the nozzle.

An embodiment of the system may include a receiver that is connected to, or integrated with, the controller, wherein the receiver is configured to receive a remotely generated signal and relay a control signal to the controller which transfers power to the pump, whereby the pump transfers fluid from the fluid container to the nozzle.

An embodiment of the system may include a transmitter that is selectively actuable to transmit the remotely generated signal for reception by the receiver.

An embodiment of the system may include a sensor that is connected to, or integrated with, the controller, and wherein the sensor is configured to automatically relay a control signal to the controller upon sensing predefined conditions, whereby the controller transfers power to the pump that transfers fluid from the fluid container to the nozzle.

An embodiment of the system may be configured wherein the frame is configured to offset the license plate from the back surface of the frame, thereby defining a storage volume at the first area of the frame between the back surface of the frame and the license plate when the license plate is secured to the frame, and one or more of the fluid container, the controller, and the pump are disposed within the storage volume of the frame.

An embodiment of the system may include a plurality of support features that offset the license plate from the back surface of the frame so that the bottom of the license plate is further away from the back surface of the frame than the top of the license plate, to thereby define a trapezoidal cross section for the storage volume.

A method of cleaning a lens includes receiving a signal to clean the lens, and transmitting fluid from a nozzle supported proximate a bottom end of a first area of a frame, upwardly, to engage the lens for cleaning the lens, the first area of the frame being configured for seating a license plate so that license plate indicia is displayed between the top end and the bottom end of the first area of the frame.

### BRIEF DESCRIPTION OF THE DRAWINGS

The following descriptions should not be considered limiting in any way. With reference to the accompanying drawings, like elements are numbered alike:

FIG. 1A is a rear view of a motor vehicle, which may utilize features of the disclosed embodiments, having a rear-view camera or image sensor (collectively referred to as a “camera”) which may be positioned as shown and has a lens that may be cleaned in accordance with a disclosed embodiment;

FIG. 1B is a rear view of a motor vehicle, which may utilize features of the disclosed embodiments, having a camera which may be positioned as shown and has a lens that may be cleaned in accordance with another disclosed embodiment;

FIG. 1C is a rear view of a motor vehicle, which may utilize features of the disclosed embodiments, having a camera which may be positioned as shown and has a lens that may be cleaned in accordance with another disclosed embodiment;

FIG. 1D is a rear view of a motor vehicle, which may utilize features of the disclosed embodiments, illustrating the license plate mounting apertures and the license plate mounting surface, which may be located on the trunk or lift gate of the motor vehicle;

FIG. 2A is the sectional view A-A as indicated in FIG. 1A, illustrating the position of the camera and an associated vehicle lamp in relation to a first-original position of the license plate on the motor vehicle;

FIG. 2B is the sectional view B-B as indicated in FIG. 1B, illustrating the position of the camera and the vehicle lamp in relation to a second-original position of the license plate on the motor vehicle;

FIG. 3A is a schematic representation of an embodiment of a lens cleaning system that is remotely controlled and that utilizes a transmitter and receiver, in accordance with a disclosed embodiment;

FIG. 3B is a schematic representation of the lens cleaning system that is automated and utilizes a sensor, in accordance with a disclosed embodiment;

FIG. 4A is an exploded detail view in perspective of the lens cleaning system, in accordance with a disclosed embodiment;

FIG. 4B is a diagrammatic front representation illustrating the frame and other components of the lens cleaning system, in accordance with a disclosed embodiment;

FIG. 5 is a perspective view illustrating the lens cleaning system as assembled, with a fluid container and fluid contained therein, in accordance with a disclosed embodiment;

FIG. 6 is a diagrammatic front representation of the lens cleaning system, in accordance with a disclosed embodiment;

FIG. 6A shows a sectional view A-A of the lens cleaning system as indicated in FIG. 6, showing a storage volume of the lens cleaning system, in accordance with a disclosed embodiment;

FIG. 7 is a side view of the lens cleaning system mounted to a motor vehicle, illustrating an angular range of a stream of fluid from a nozzle of the lens cleaning system, in accordance with a disclosed embodiment;

FIG. 8A is a side view of a stream of fluid impinging on a lens for cleaning the lens with the lens cleaning system;

FIG. 8B is a front view of a stream of fluid impinging on a lens for cleaning the lens with the lens cleaning system;

FIG. 9 is an illustration of an interior video display screen of a motor vehicle with a nozzle assembly of the lens cleaning system appearing in the field of view of the camera, in accordance with a disclosed embodiment;

FIG. 10A is a diagrammatic front representation of the lens cleaning system illustrating a left-side mounting position of the nozzle and the angular range of the stream of fluid, in accordance with a disclosed embodiment;

FIG. 10B is a diagrammatic front representation of the lens cleaning system illustrating a right-side mounting position of the nozzle and the angular range of the stream of fluid, in accordance with a disclosed embodiment;

FIG. 11 is a diagrammatic representation of the nozzle assembly of the lens cleaning system that is directionally adjustable, in accordance with a disclosed embodiment;

FIG. 11A1 is the sectional view A-A of the nozzle assembly as indicated in FIG. 11, in accordance with a disclosed embodiment;

FIG. 11A2 is the sectional view A-A of the nozzle assembly as indicated in FIG. 11, in accordance with a disclosed embodiment;

FIG. 11A3 is the sectional view A-A of the nozzle assembly as indicated in FIG. 11, in accordance with a disclosed embodiment;

FIG. 11A4 is the sectional view A-A of the nozzle assembly as indicated in FIG. 11 and showing an aiming pin tool inserted into the nozzle assembly for aiming the nozzle, in accordance with a disclosed embodiment;

FIG. 11B is a diagrammatic perspective representation of the nozzle housing body of the lens cleaning system configured with interlock features, in accordance with a disclosed embodiment;

FIG. 11C is a diagrammatic perspective representation of the nozzle housing cap of the lens cleaning system configured with interlock features, in accordance with a disclosed embodiment;

FIG. 11D is an exploded detail view in perspective of the nozzle assembly of the lens cleaning system, in accordance with a disclosed embodiment;

FIG. 11E is a diagrammatic representation of the lens cleaning system showing the aiming pin tool inserted into the nozzle assembly for aiming the nozzle, in accordance with a disclosed embodiment;

FIG. 12 is a diagrammatic side representation of a wash fluid filler tool for the lens cleaning system, in accordance with a disclosed embodiment;

FIG. 13 is a diagrammatic side representation of the lens cleaning system in a partially inverted orientation as mounted onto a raised trunk or lift gate of a motor vehicle, in accordance with a disclosed embodiment;

FIG. 14 is a perspective view of the lens cleaning system having a frame that is configured to reposition the vehicle license plate rearward and downward when mounted to a motor vehicle, in accordance with a disclosed embodiment;

FIGS. 15 and 15A are diagrammatic front and side representations of the lens cleaning system having a frame that is configured to reposition the vehicle license plate rearward and downward when mounted to a motor vehicle, in accordance with a disclosed embodiment;

FIG. 16 is a side view of the lens cleaning system mounted to a motor vehicle and having a frame that is configured to reposition the vehicle license plate rearward and downward, in accordance with a disclosed embodiment;

FIG. 17 is a diagrammatic front representation of the lens cleaning system which is configured with a greater volume within a frame in comparison to the embodiments illustrated in FIGS. 6 and 15, in accordance with a disclosed embodiment;

FIG. 18 is a perspective view of the lens cleaning system that is configured to be mounted to different motor vehicle models that may have several different positions or patterns for the license plate mount apertures, in accordance with a disclosed embodiment;

FIGS. 19 and 19A are diagrammatic front and side representations of the lens cleaning system that is configured to be mounted to different motor vehicle models that may have several different positions or patterns for the license plate mount apertures, in accordance with a disclosed embodiment;

FIG. 20 is a perspective view of the lens cleaning system having a frame that is configured to reposition the vehicle license plate rearward when mounted to a motor vehicle, in accordance with a disclosed embodiment;

FIGS. 21 and 21A are diagrammatic front and side representations of the lens cleaning system having a frame that is configured to reposition the vehicle license plate rearward when mounted to a motor vehicle, in accordance with a disclosed embodiment;

FIG. 22 is a perspective view of the lens cleaning system configured with certain components of the system disposed on the sides of the vehicle license plate when mounted to a motor vehicle, in accordance with a disclosed embodiment;

FIGS. 23 and 23A are diagrammatic front and side representations of the lens cleaning system configured with certain components of the system disposed on the sides of the vehicle license plate when mounted to a motor vehicle, in accordance with a disclosed embodiment;

FIG. 24 is a perspective view of the lens cleaning system configured to be mounted to an exterior surface of a motor vehicle, in accordance with a disclosed embodiment;

FIG. 25 is a flow chart illustrating a method of cleaning a lens with a lens cleaning system according to an embodiment; and

FIGS. 26 and 26A show additional features of the embodiments being utilized to execute the method shown in the flow chart of FIG. 25.

### DETAILED DESCRIPTION

A detailed description of one or more embodiments of the disclosed apparatus and method are presented herein by way of exemplification and not limitation with reference to the Figures. An advantage of some embodiments described herein may include a high degree of adaptability of the self-contained motor vehicle camera cleaning system to various motor vehicle models having a variety of body styles, camera positions and camera body shapes. A further advantage of some embodiments described herein may include ease of installation of the self-contained motor vehicle camera cleaning system, without the need for special skills or complex modifications to the motor vehicle. These and other benefits of one or more aspects will become apparent from a consideration of the ensuing description and accompanying drawings.

Motor Vehicle Features

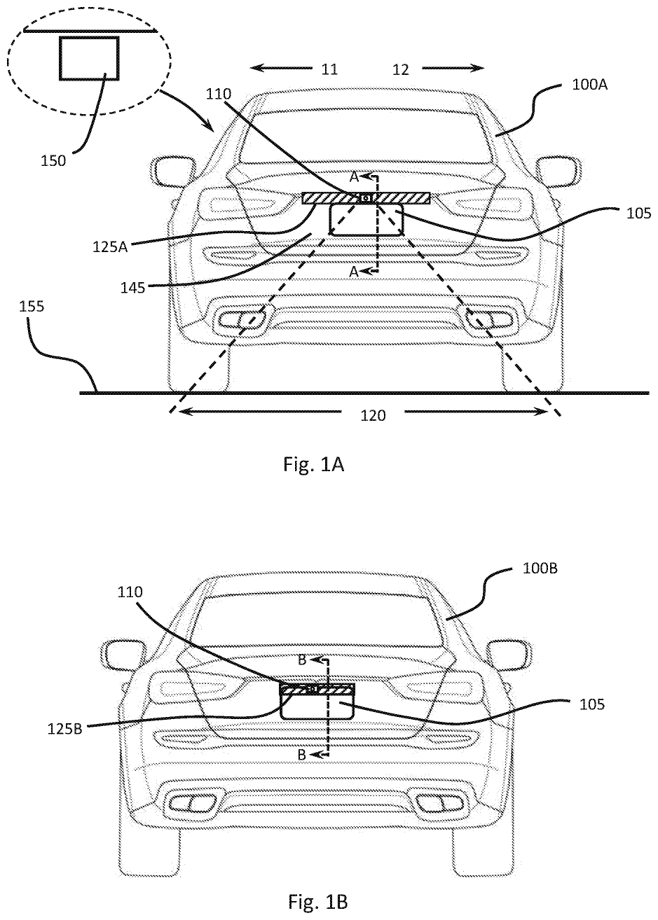

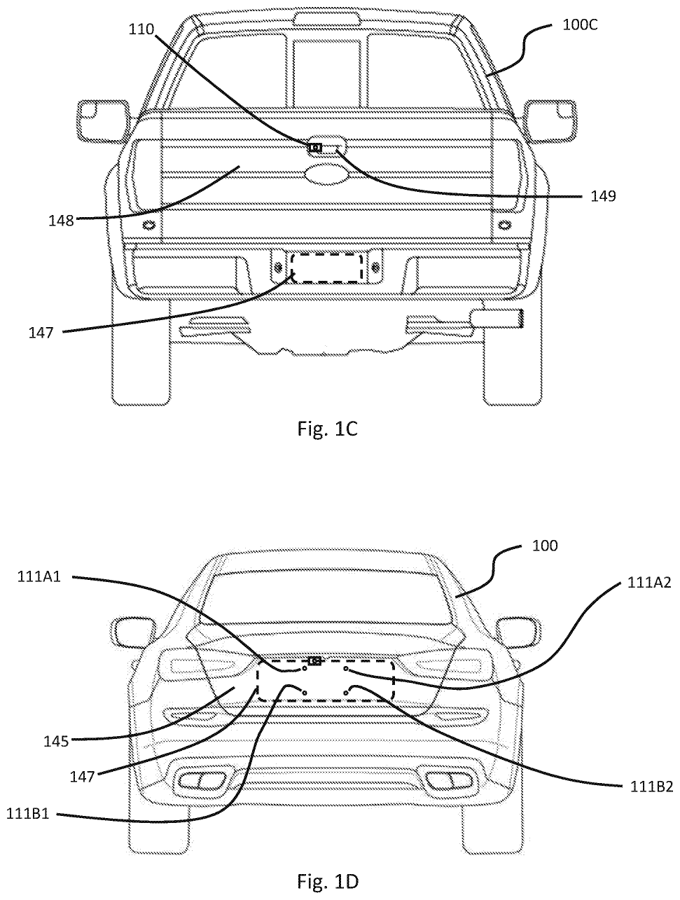

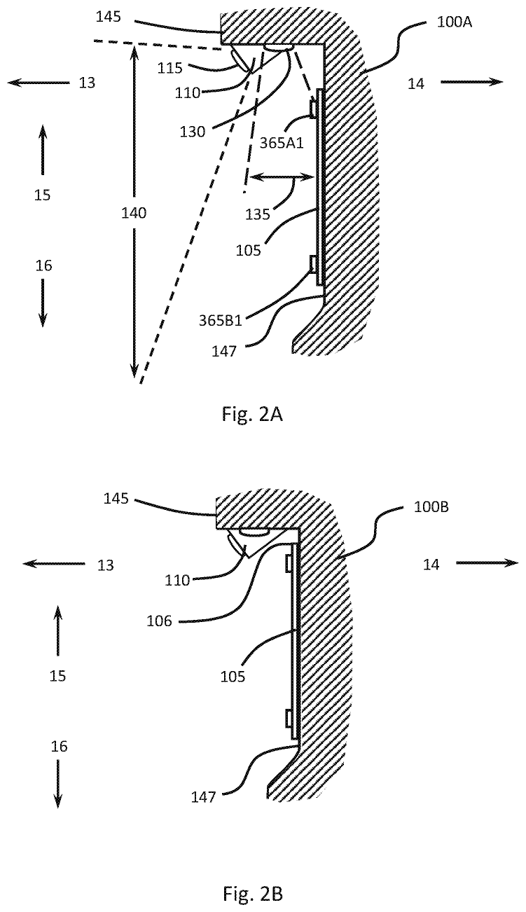

FIGS. 1-2 show features of a motor vehicle 100, otherwise referred to as a vehicle 100, that may benefit from one or more embodiments of a self-contained motor vehicle camera cleaning system 400, otherwise referred to as a lens cleaning system 400.

More specifically, FIG. 1A illustrates a rear view of a first vehicle 100A. The first vehicle 100A includes a placement of a rear-view camera 110 (also referred to as a camera 110) within a first zone 125A that is located above a license plate 105. The license plate 105 is illustrated in FIG. 1A in a first-original mounting position and is located on a trunk or lift gate 145 of the first vehicle 100A. This figure also shows a lateral field of view 120 of the camera 110, as seen on an interior video display screen 150 of the first vehicle 100A, and with the camera 110 pointing rearward and downward, toward the ground 155. As used herein, a left direction 11 and a right direction 12 may be also respectively referred to as a first lateral direction 11 and an opposite second lateral direction 12, which are substantially parallel to each other.

FIG. 1B illustrates a rear view of a second vehicle 100B, with a placement of the camera 110 within a second zone 125B that is located partially above the license plate 105. The license plate 105 in FIG. 1B is located in a second-original mounting position.

FIG. 1C illustrates a rear view of a third vehicle 100C having the camera 110 located on a tailgate 148, and proximate a tailgate latch 149. A license plate mounting surface 147 of the third vehicle 100C is shown, which is spaced apart from the camera 110.

FIG. 1D is a rear view of the vehicle 100, illustrating first through fourth (top and bottom pairs) license plate mounting apertures 111, which include apertures 111A1, 111A2, 111B1, 111B2 located on the license plate mounting surface 147 of the trunk or lift gate 145 of the vehicle 100.

FIG. 2A illustrates section A-A of FIG. 1A for the first vehicle 100A. The license plate 105 is secured in the first-original mounting position to the license plate mounting surface 147 of the first vehicle 100A. Mounting features 365 are shown, which include first and second upper mounting features 365A1, 365A2, which may be bolts or screws, and first and second lower mounting features 365B1, 365B2, which may also be bolts or screws. The mounting features 365 engage the license plate mounting apertures 111 of the first vehicle 100A.

The license plate 105 may be located in a recessed area within the trunk or lift gate 145 of the first vehicle 100A. As shown in FIG. 1A, the camera 110 may be located above the license plate 105, and within the first zone 125A. A lens 115 may be aimed in a rearward direction 13, and in a vertically downward direction 16, having a vertical field of view 140. As used herein, the rearward direction 13 and an opposing forward direction 14 may also be respectively referred to as a third lateral direction 13, and an opposite fourth lateral direction 14 that are substantially parallel to each other and perpendicular to the first and second lateral directions 11,12. Also as used herein, a vertically upward direction 15 and the vertically downward direction 16 may also be respectively referred to as a fifth lateral direction 15, and an opposite sixth lateral direction 16 that are parallel with each other and perpendicular to the first through fourth lateral directions 11-14.

In addition, vehicles may be equipped a lamp 130, which may be placed above the license plate 105. The lamp 130 may illuminate an approximate range 135 on the vehicle 100 to ensure visibility of the license plate 105 in relatively dark conditions.

FIG. 2B illustrates section B-B of FIG. 1B for the second vehicle 100B having the camera 110 that is positioned partially above (e.g., partially overlapping in the vertical direction) and relatively near to a top edge 106 of the license plate 105. The license plate 105 is secured in the second-original mounting position to the license plate mounting surface 147 of the second vehicle 100B. This arrangement is noteworthy because it presents a challenge which is overcome by some of the disclosed embodiments described herein. Specifically, some of the disclosed embodiments are configured for the avoidance of interference between the camera 110 of the second vehicle 100B and the lens cleaning system 400.

System Operation

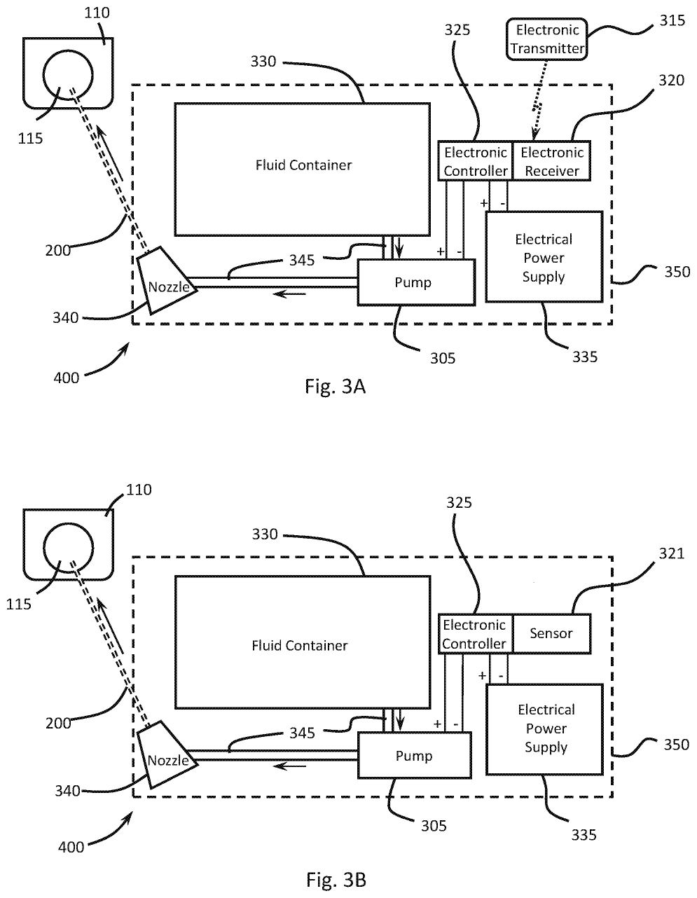

FIG. 3A is a schematic representation of an embodiment of the lens cleaning system 400 which is remotely controlled. This embodiment of the lens cleaning system 400 utilizes a transmitter 315 and a receiver 320, operationally connected to a controller 325, each of which may be electric or electronic for selectively controlling the lens cleaning system 400 for cleaning the lens 115 of the camera 110. Specifically, the lens 115 may be subject to field of view impairment by dirt, debris, snow, ice, salt and water droplets that may accumulate thereon. The receiver 320 may be secured to a frame 350 and connected to, or integrated with, the controller 325. The receiver 320 may be configured to receive a remotely generated signal from the transmitter 315. The communication technology used by the transmitter 315 and receiver 320 may be wireless, such as a 433 MHz radio signal, a 2.4 GHz Bluetooth radio signal, or other wireless communication technology. However, a wired connection may also be used to transfer a remotely generated signal to activate the cleaning function of the lens cleaning system 400.

Upon receipt of a remotely generated signal, the receiver 320 may then relay a control signal to the controller 325, which may then transfer power, which may be electric power, from a power supply 335, which may be an electric power supply, to a pump 305. The system may be configured to utilize the power supply 335 that may be secured to the frame 350 and may be independent of the vehicle 100. However, an embodiment of the lens cleaning system 400 may be configured to draw power directly from the vehicle 100. In addition, power may be provided by connecting the lens cleaning system 400 to the vehicle 100 power supply for the camera 110. A wash control signal may be synchronized with an actuation signal for the camera 110, which may be generated by the vehicle 100 when the vehicle 100 is initially operated in the rearward direction 13.

The pump 305, when activated, then transfers wash fluid from a fluid container 330 that is unpressurized, which may be integrated with the frame 350, to a nozzle 340 via flexible fluid tubing 345 or other conduit suitable for transporting fluid. The nozzle 340 then directs a stream or spray of fluid 200 to the lens 115 to remove foreign matter that may reside on the exterior surface of the lens 115.

The controller 325 may be configured to operate the pump 305 on a momentary basis. The pump 305 may operate for the duration that a button on the transmitter 315 is engaged by the operator (e.g., depressed). However, in order to minimize excessive wash fluid consumption by the operator, the controller 325 may be configured so that the press of a button on the transmitter 315 may cause a predetermined timed response by the pump 305. For example, engaging the transmitter 315 may result in a stream or spray of wash fluid 200 for one-half (0.5) second in duration, or may result in a limited set of quick bursts of wash fluid.

FIG. 3B is a schematic representation of the lens cleaning system 400 that utilizes a sensor 321 for the automated cleaning of the lens 115 of the camera 110. The sensor 321 is operationally connected to, or integrated with, the controller 325. The sensor 321 may be configured to automatically send a control signal to the controller 325 upon sensing predefined conditions. Such predefined conditions may include the initial activation of the camera 110, the initial vibration associated with starting the engine of the vehicle 100, the accumulation of foreign matter on the exterior surface of the lens 115, or some other predetermined condition, e.g., compared against a predetermined threshold, that may warrant the cleaning of the lens 115. In addition, the sensor 321 may be configured to automatically detect foreign matter on a surface that is exposed to the environment outside of the vehicle 100, and the surface may be concurrently cleaned with the automated activation of the lens cleaning system 400. Upon receiving a control signal, the controller 325 may then transfer power from the power supply 335 to the pump 305 for a predetermined duration. The pump 305 may then transfer wash fluid from the fluid container 330 to the nozzle 340 for cleaning the lens 115. In an embodiment, the controller 325 may be programmable to automatically activate the lens cleaning system 400 at predetermined times and for predetermined durations.

Mechanical Arrangement

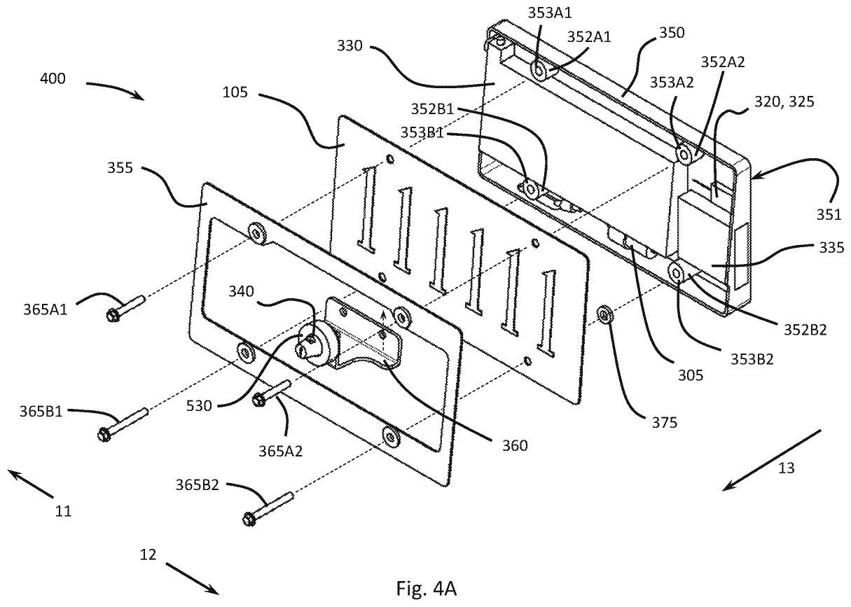

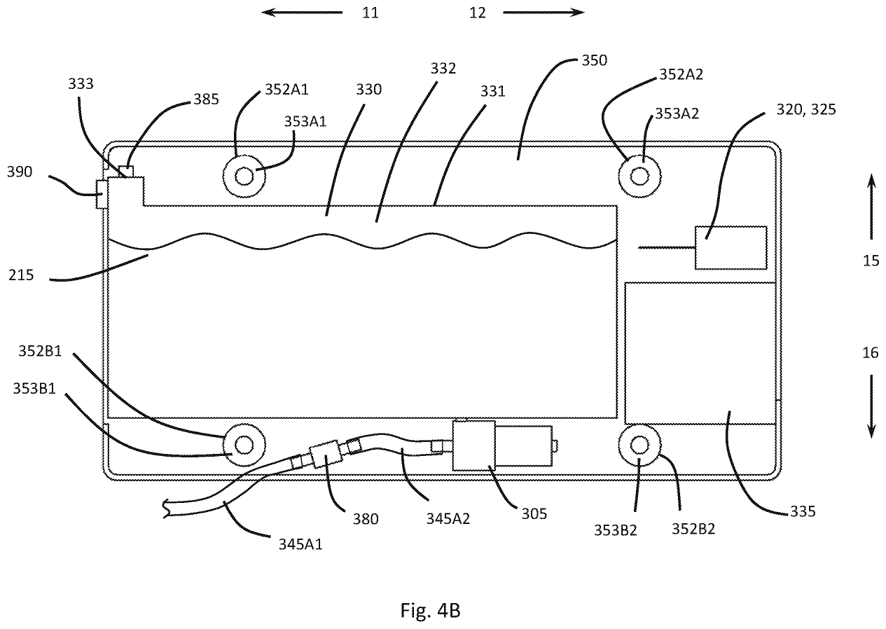

FIG. 4A is a perspective view of an exploded detail of an embodiment of the lens cleaning system 400 that may be suitable for mounting to the license plate mounting surface 147 of the vehicle 100. The license plate 105 may be repositioned in the rearward direction 13, relative to the first-original license plate position (as illustrated in FIG. 2A), by the frame 350 of the lens cleaning system 400. The frame 350 may be a flat plate including a back surface 351 with support features 352 to offset the license plate 105 from the back surface 351 by a predetermined distance. A plurality of support features 352, illustrated as first through fourth (top and bottom pairs) support features 352A1, 352A2, 353B1, 352B2, which may be integral standoffs with respective center fastener receiving apertures configured to receive respective fasteners, provide first and second upper seating surfaces 353A1, 353A2 (generally referred to as 353A) and first and second lower seating surfaces 353B1, 353B2 (generally referred to as 353B) for positioning the license plate 105 against the frame 350. A nozzle bracket 360, which may be manufactured from aluminum or steel to achieve a desired stiffness, and a spacer 375 are each positioned between one of the first and second lower seating surfaces 353B1, 353B2 and the license plate 105.

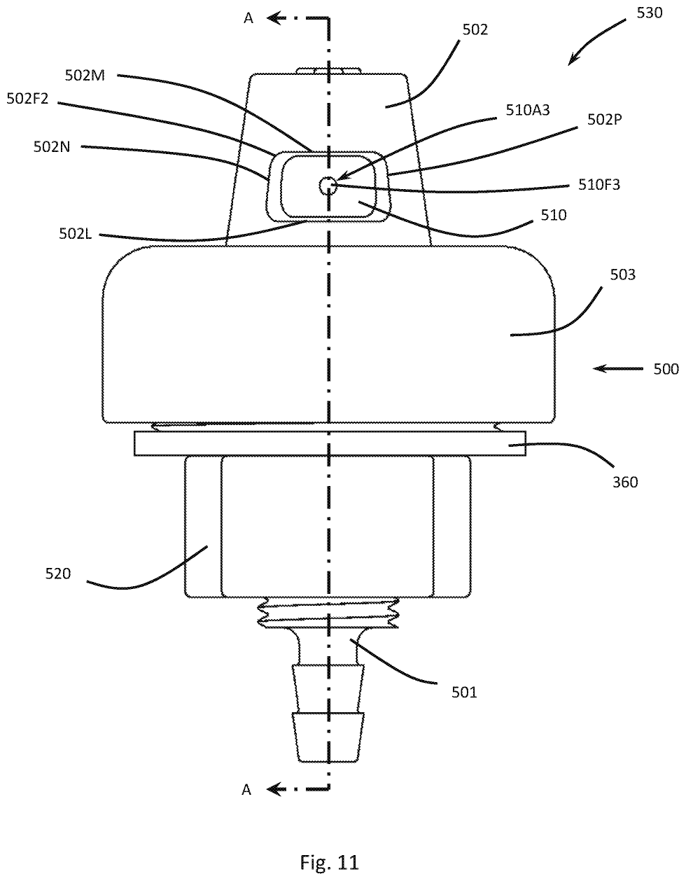

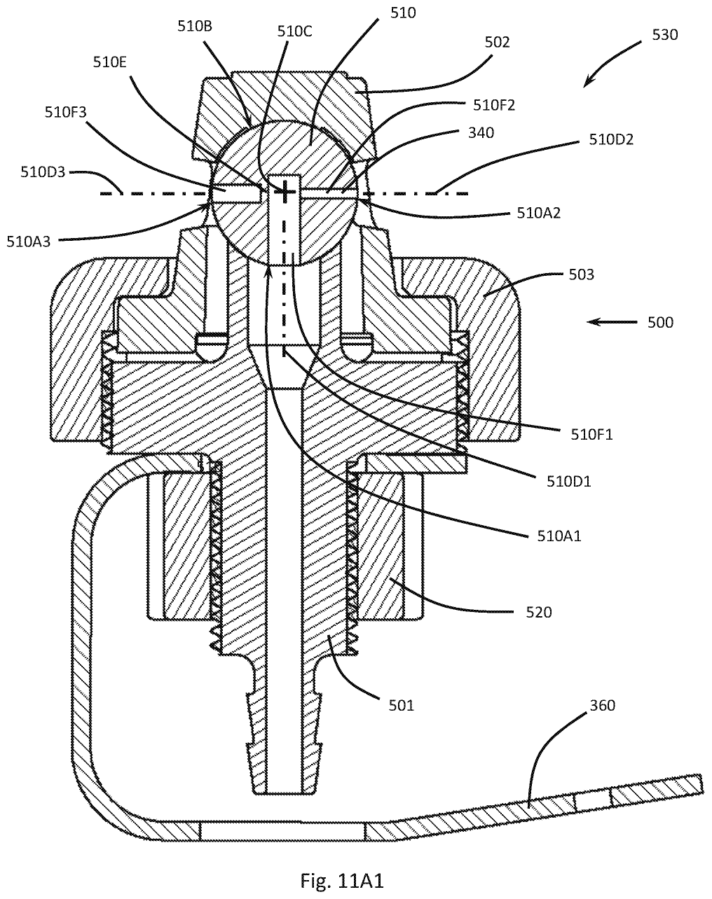

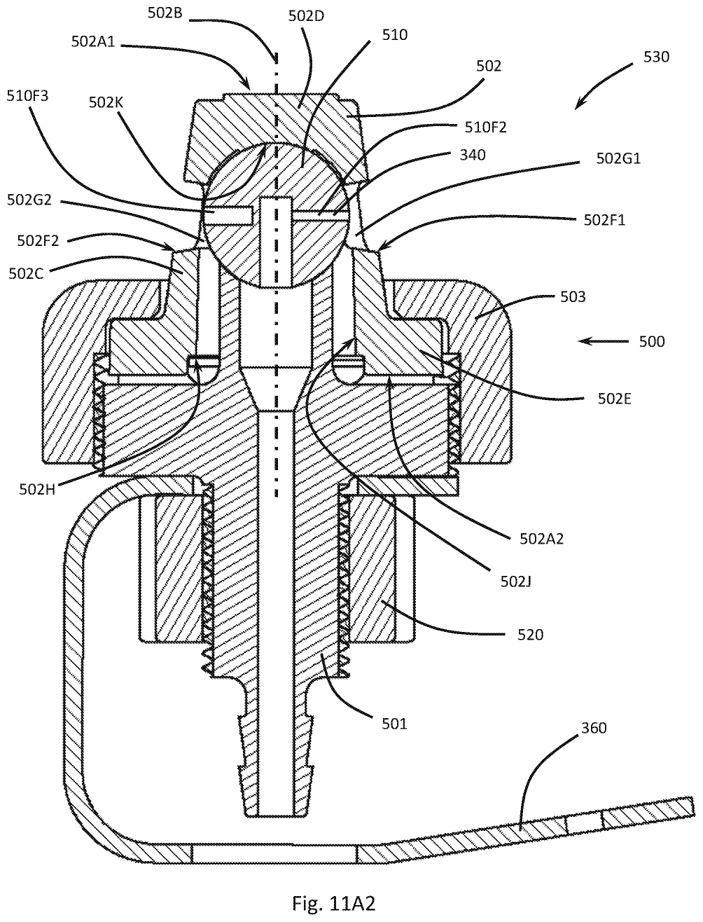

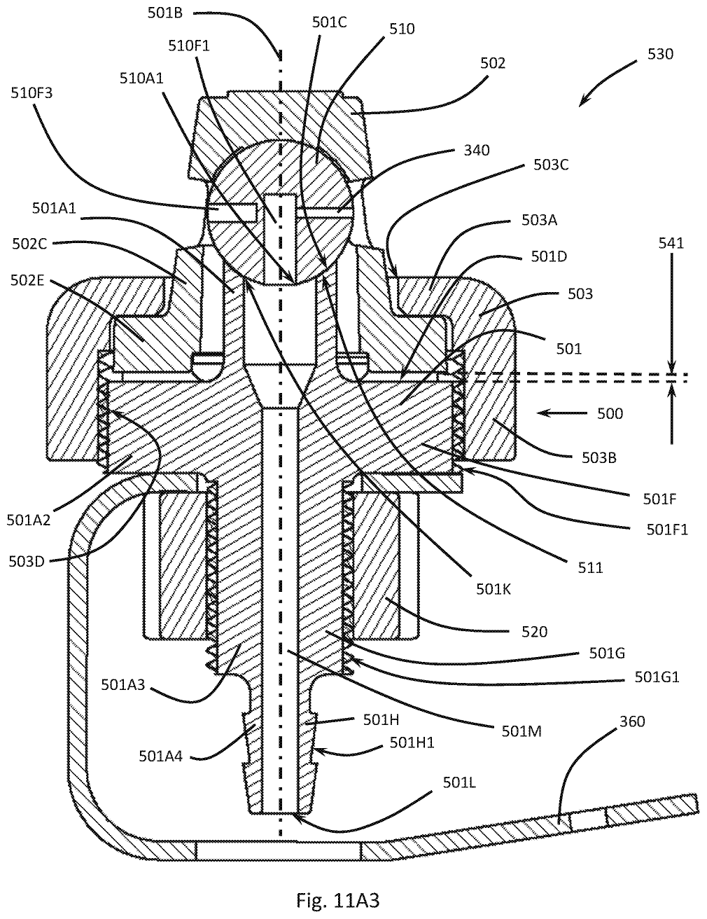

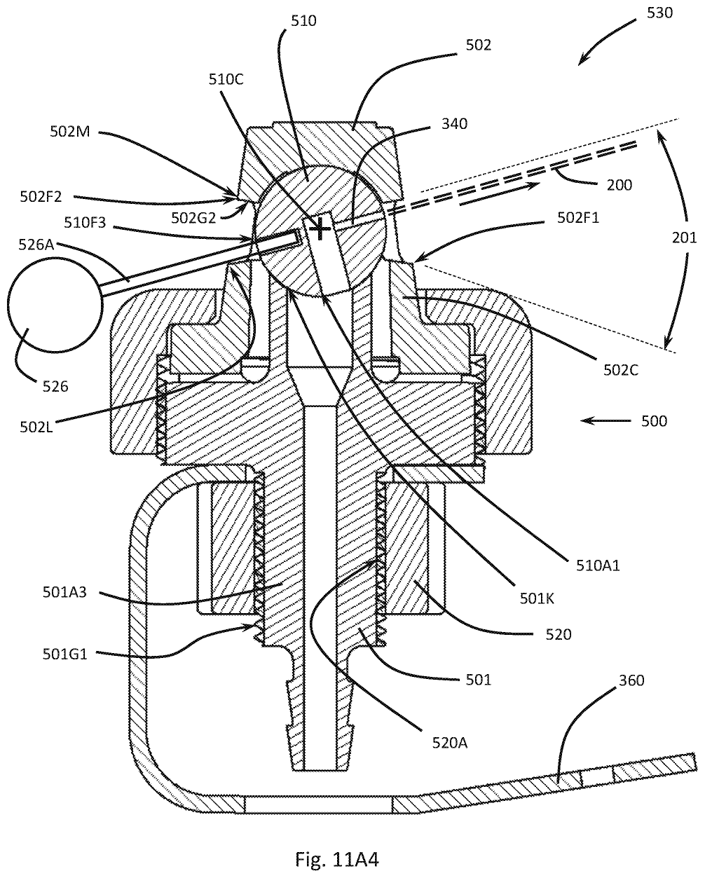

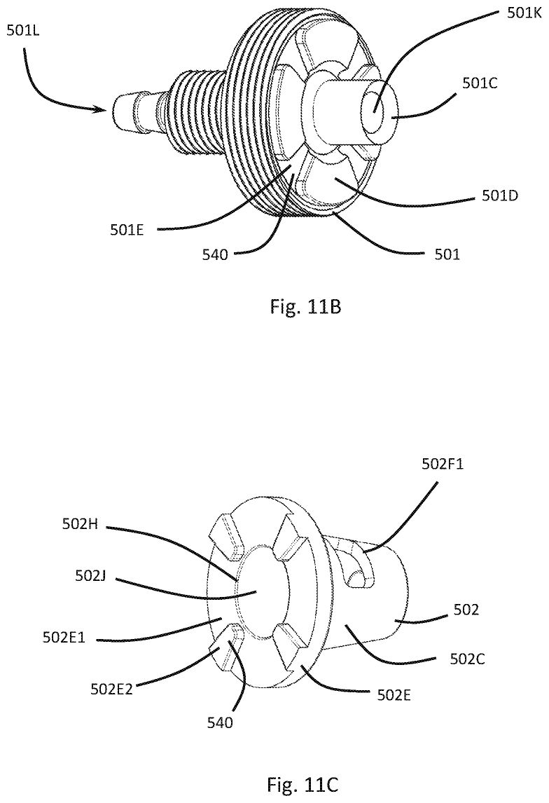

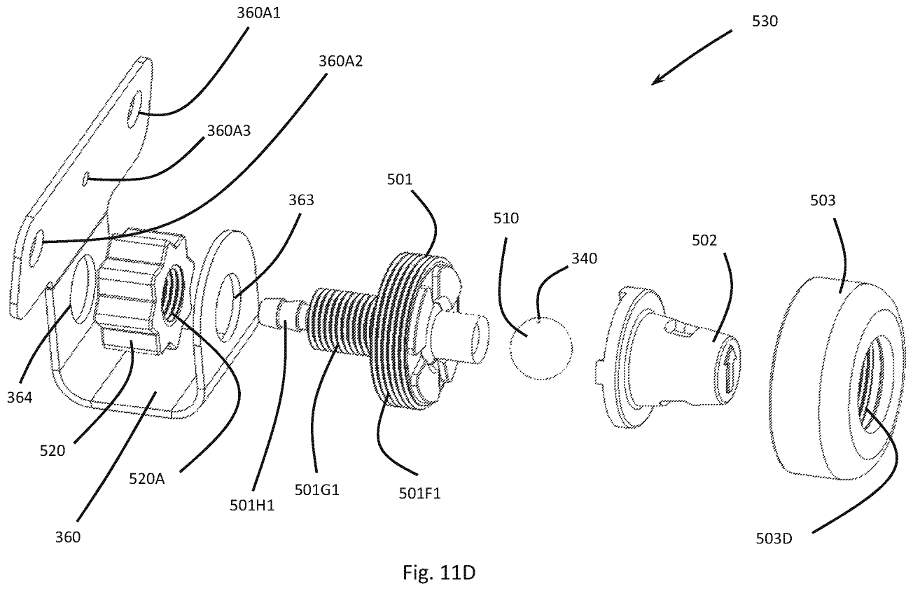

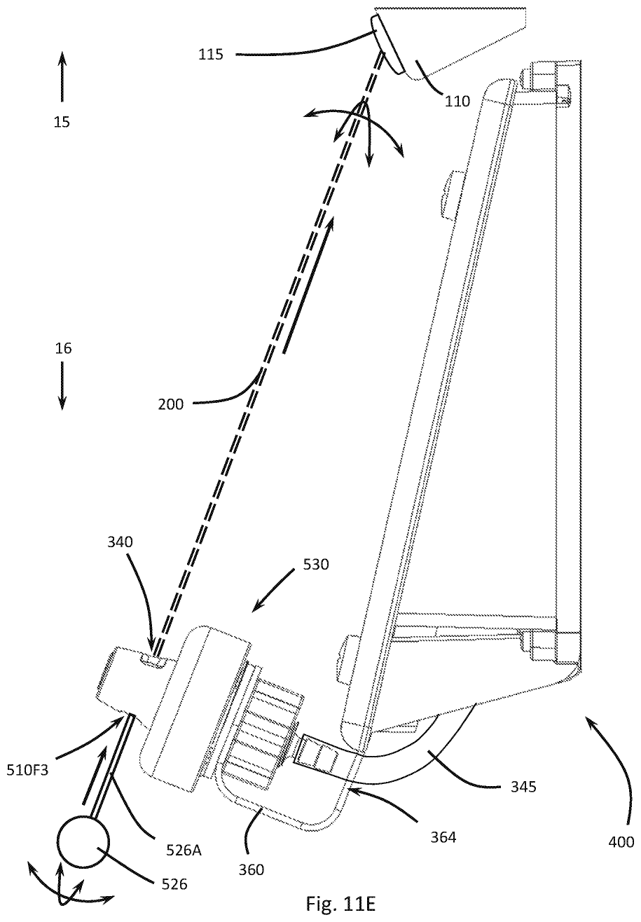

The nozzle bracket 360 may be configured to be mounted to the left (first) or right (second) lower seating surfaces 353B1, 353B2, and the spacer may be mounted to the one of the lower seating surfaces 353B that is located opposite the nozzle bracket 360. The nozzle bracket 360 supports the nozzle assembly 530, which includes a nozzle 340 having an adjustable aim. The nozzle bracket 360 may be configured with first and second mounting apertures 360A1, 360A2 (FIG. 11D) that enable mounting of the nozzle bracket 360 to the first lower seating surface 353B1 or second lower seating surface 353B2 using either one of the left (first) or right (second) lower mounting features 365B1, 365B2. The nozzle bracket 360 may be configured with a third mounting aperture 360A3 (FIG. 11D) for a mounting feature, which may be a bolt or screw, that also secures the nozzle bracket 360 to the frame 350, thereby preventing rotation of the nozzle bracket 360 around either the left (first) or right (second) lower mounting features 365B1, 365B2 when the nozzle bracket 360 is secured to the frame 350.

For the above embodiment, the lens cleaning system 400 is mounted to the vehicle 100 using the mounting features 365, including the first and second upper mounting features 365A1, 365A2 and the first and second lower mounting features 365B1, 365B2. The mounting features 365 may secure the lens cleaning system 400 to the vehicle 100 utilizing the first through fourth license plate mounting apertures 111A1, 111A2, 111B1, 111B2 of the vehicle 100 (FIG. 1D). This mounting method makes use of pre-existing features of the vehicle 100 and may be relatively simple and convenient for the owner of the vehicle 100. As some vehicles may have been manufactured with only first and second upper license plate mounting apertures 111A1, 111A2, the vehicle owner may decide to drill the first and second lower license plate mounting apertures 111B1, 111B2. Even for this scenario, the installation of the lens cleaning system 400 may require relatively simple skills and minor modifications to the vehicle 100 that may not be visible if the lens cleaning system 400 is subsequently removed. A license plate border cover 355 is also illustrated in FIG. 4A.

FIG. 4B is a diagrammatic representation illustrating an embodiment of the frame 350 and various components of the lens cleaning system 400 positioned within the frame 350. This figure illustrates the receiver 320 integrated with the controller 325, which is connected to the power supply 335, which powers the pump 305 through operational connections, which may be electrical connections, with the controller 325, as illustrated in FIGS. 3A and 3B. FIG. 4B also illustrates the fluid container 330, which includes a container wall 331 defining an internal chamber 332 that holds wash fluid 215. A fluid container check valve 385 is positioned within a fluid container aperture 333 in the fluid container 330 so that air may enter the fluid container 330 during the operation of the lens cleaning system 400. A filler port 390, for filling the fluid container 330 with wash fluid 215, is also positioned on the fluid container 330. A nozzle check valve 380, in fluid communication with and between the fluid container 330 and the nozzle 340, is intended to prevent wash fluid leakage at the nozzle 340 when the pump 305 is not operating. As illustrated, the nozzle check valve 380 is between adjacent segments 345A1, 345A2 of the fluid tubing 345. Also included are the support features 352, illustrated as the upper supports 352A1, 352A2 and the lower supports 352B1, 352B2. The seating surfaces 353 for positioning the license plate 105, which include the upper seating surfaces 353A1, 353A2 and lower seating surfaces 353B1, 353B2 are also illustrated.

To simplify FIG. 4B and other figures included herein, features that are disclosed in FIGS. 3A and 3B that have the same reference number shall be construed the same and shall be construed as having the same component connections unless otherwise indicated.

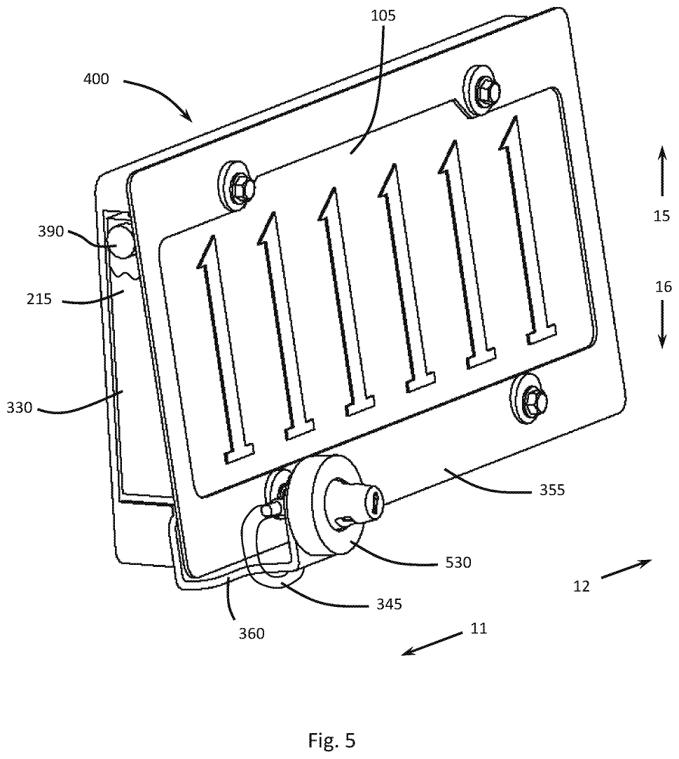

FIG. 5 is a perspective view illustrating an embodiment of the lens cleaning system 400 as assembled. A level of wash fluid 215 within the fluid container 330, which may be constructed of a transparent or semitransparent plastic such as high-density polyethylene or other suitable material, may be visually observed on the exterior surface of the fluid container 330. The license plate border cover 355, behind which is an outer perimeter of the license plate 105, is also illustrated. An embodiment of the nozzle assembly 530 is shown with fluid tubing 345 extending away from the nozzle assembly 530 in the left direction 11, and curving down 16 and under the nozzle bracket 360 in the right direction 12. As described above, the nozzle 340 of the nozzle assembly 530 is in fluid communication with the pump 305 through the fluid tubing 345. Other embodiments of the nozzle assembly 530 and the nozzle bracket 360, such as those illustrated in FIGS. 11D and 11E, may be configured for alternate positioning of the nozzle assembly 530 relative to the license plate 105 as shown, and alternate routing of the fluid tubing 345 relative to the nozzle bracket 360 as shown.

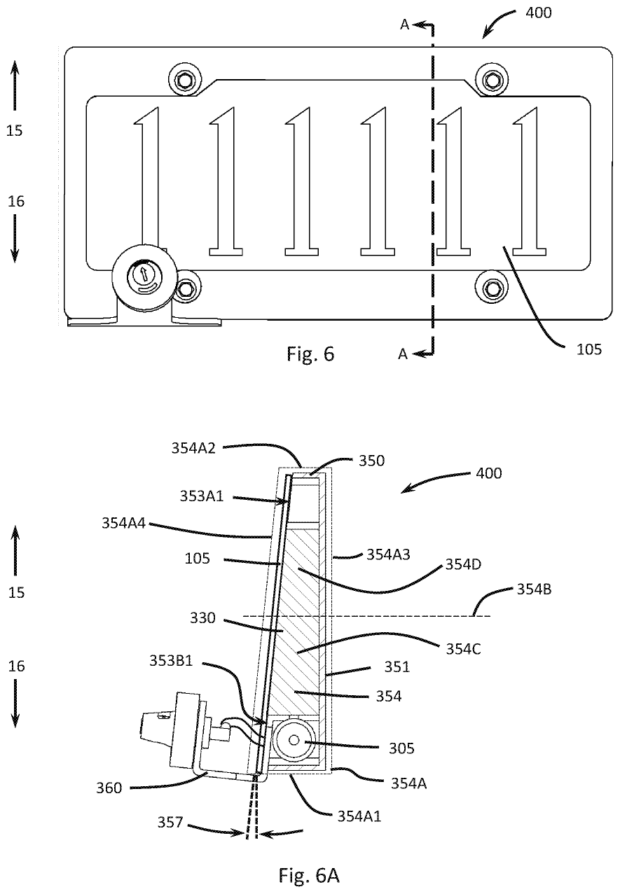

FIGS. 6 and 6A are front and sectional views illustrating an embodiment of the lens cleaning system 400. Together, the back surface 351 of the frame 350, the seating surfaces 353 (including seating surfaces 353A1, 353A2, 353B1, 353B2), and the license plate 105 form a storage volume 354 with a trapezoidal cross section 354A (or trapezoidal profile). The trapezoidal cross section 354A may be formed by a bottom edge 354A1 that is longer than a top edge 354A2, the top edge 354A2, a back edge 354A3 extending vertically between the top and bottom edges 354A1, 354A2, and a front-angled edge 354A4 also extending between the top and bottom edges 354A1, 354A2. The nozzle bracket 360 and the spacer 375 (FIG. 4A) may be located between the lower seating surfaces 353B1, 353B2 and the license plate 105. The license plate 105 may be in a rotated position as indicated by angle 357, which may be an acute angle, i.e., aligned with the front-angled edge 354A4 of the trapezoidal cross section 354A. The fluid container 330 and the pump 305 may be disposed within the storage volume 354.

Referring again to FIG. 6A, the lower half 354C of the storage volume 354 is indicated by the vertically downward direction 16, below a reference line 354B. The upper half 354D of the storage volume 354 is indicated by the upward direction 15, above reference line 354B. As illustrated, due to the trapezoidal configuration of the storage volume 354, the lower half 354C of the storage volume 354 has a greater volume than the upper half 354D of the storage volume 354.

There may be several advantages of an embodiment of the lens cleaning system 400 configured to form the trapezoidal cross section 354A as illustrated in FIG. 6A. The trapezoidal cross section 354A may allow for installation of the lens cleaning system 400 onto a wide variety of models of vehicles 100 without resulting in interference between the lens cleaning system 400 and the vehicle camera 110, which may be positioned near to the license plate mounting surface 147 as illustrated in FIGS. 2A and 2B. In addition, it may allow for the proper function of the vehicle license plate lamp 130, which is intended to illuminate the license plate 105. Given the considerations of proper clearance with the camera 110 and proper function of the lamp 130, the increased volume of the lower half of storage volume 354 may allow for a larger version of the pump 305, a larger version of the power supply 335, and a larger version of the fluid container 330, in comparison to the lens cleaning system 400 embodied without the trapezoidal cross section 354A.

Nozzle Position and Configuration

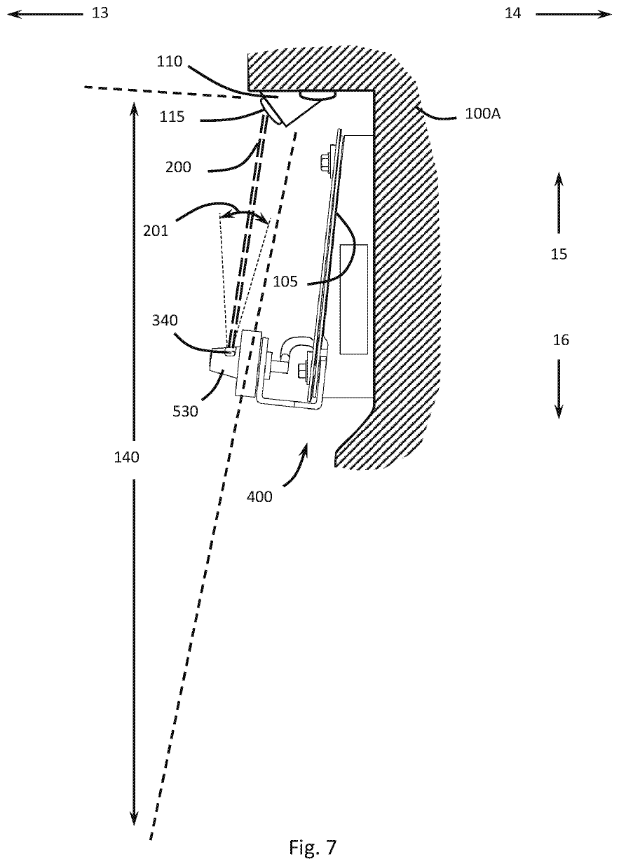

FIG. 7 is a side view of an embodiment of a lens cleaning system 400 that is installed onto the vehicle 100A, and illustrates the position of the nozzle 340 in relation to the position of the lens 115. The nozzle assembly 530 includes the nozzle 340 having an adjustable aim. A first angular range 201, which is a fore/aft angular range of the stream or spray of fluid 200, is illustrated in FIG. 7. Also as illustrated, the nozzle 340 is positioned below the camera 110 in the vertically downward direction 16, and within the camera 110 field of view 140. Also, for the embodiment of the lens cleaning system 400 as illustrated, the fluid stream 200 is a substantially solid stream of wash fluid 215.

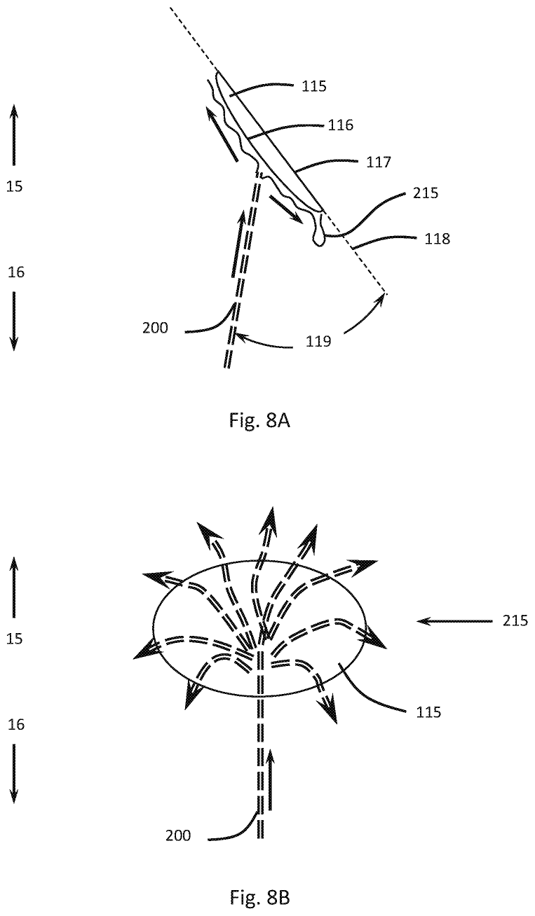

For the embodiment of lens cleaning system 400 illustrated in FIG. 7, FIG. 8A illustrates a side view of the fluid stream 200 impacting the lens 115 at an aim angle 119 of approximately forty-five (45) degrees. The aim angle 119 is measured from a plane 118 that is defined by an outer edge 117 of an exterior convex surface 116 of the lens 115. As illustrated in FIG. 8B, which is a front view, the convex curvature of the lens 115, in combination with the force of gravity acting in the downward direction 16, may disperse the wash fluid 215 in all directions over the lens 115, enabling the removal of debris from the entire exterior convex surface 116 of the lens 115. Although a shallower aim angle 119 may be utilized to push debris across the exterior convex surface 116 of the lens 115, an aim angle 119 of approximately forty-five (45) degrees, as illustrated in FIG. 8A, may also be effective in removing debris from the lens 115. An embodiment of the lens cleaning system 400 may be configured with the aim angle 119 within a range of zero (0) to one hundred eighty (180) degrees.

A substantially solid (uninterrupted) fluid stream 200 may enable the nozzle 340 to be positioned away from the lens 115 by a lens-nozzle separation distance of more than four hundred (400) millimeters. However, other fluid stream or spray patterns, as well as closer or further positioning of the nozzle 340 to the lens 115, may be suitable for other embodiments of the lens cleaning system 400. In addition, the nozzle assembly 530 may include a plurality of nozzles 340 (i.e. a showerhead configuration) for the generation of multiple fluid streams 200, which may be parallel fluid streams 200. Further, an embodiment of the lens cleaning system 400 may include a plurality of nozzle assemblies 530 so that a single lens 115 may be cleaned by multiple fluid streams 200, or so that multiple lenses 115 on the vehicle 100 may be cleaned.

The wash fluid 215 may be automotive windshield washer fluid, which may be predominately methanol, that may be formulated for cold weather or all-season driving conditions. However, other cleaning fluids may also be suitable for the effective function of the lens cleaning system 400. The advantages of windshield washer fluid formulated for cold weather may include a low freezing point, which may be minus thirty degrees Celsius, and capabilities to dissolve ice and salt and to remove debris. In addition, methanol has a low liquid surface tension of approximately twenty-three (23) milliNewtons per meter (mN/m) at twenty (20) degrees Celsius, in comparison to water which has a greater surface tension of approximately seventy-three (73) mN/m. This low surface tension may enable a methanol-based windshield washer fluid to displace water droplets that may form on the lens 115, while potentially avoiding the formation of methanol droplets on the lens 115 when cleaning the lens 115, which may obscure the field of view of the camera 110. Therefore, windshield washer fluid may be formulated for a sheeting action, where the fluid glides off a surface as a sheet of liquid, rather than clinging to the surface as multiple droplets. Thus, a suitable wash fluid 215 may contribute to the overall cleaning effectiveness of the lens cleaning system 400.

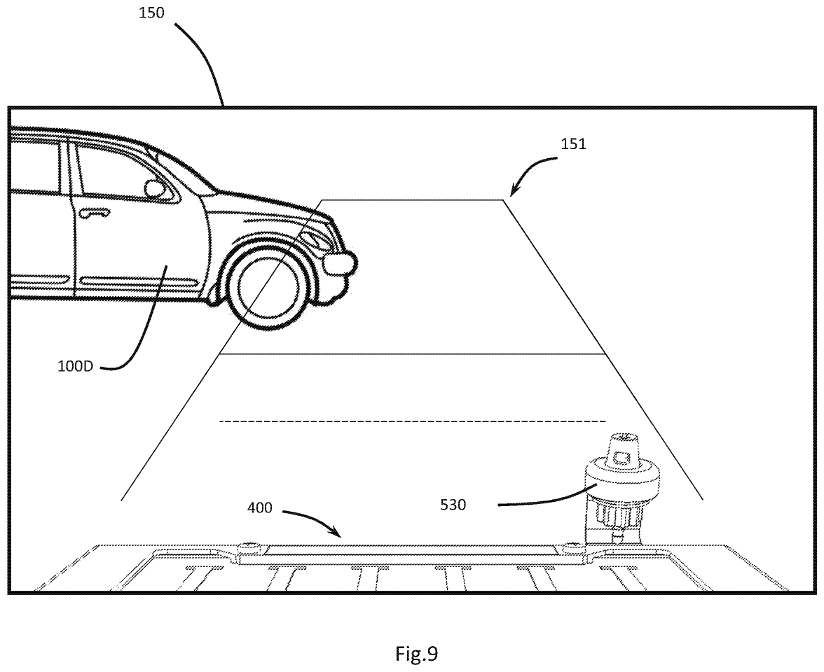

FIG. 9 illustrates the camera 110 field of view as displayed on the interior video display screen 150 of the vehicle 100A, with an embodiment of the lens cleaning system 400 installed onto the vehicle 100A as illustrated in FIG. 7. Vehicle trajectory zone guidelines 151 are also illustrated, as well as another vehicle 100D located behind the vehicle 100A. The nozzle assembly 530 may appear within the field of view, as illustrated. However, a relatively small portion of the field of view may be obscured. Critical areas of the video display screen 150, for detecting cross traffic or other safety concerns, may not be affected. Thus, intrusion of the nozzle assembly 530 into the field of view of the camera 110 may be possible without degrading the obstacle detection capability of an operator of the vehicle 100. The lens cleaning system 400 may also be configured so that the nozzle assembly 530 is positioned outside the field of view of the camera 110.

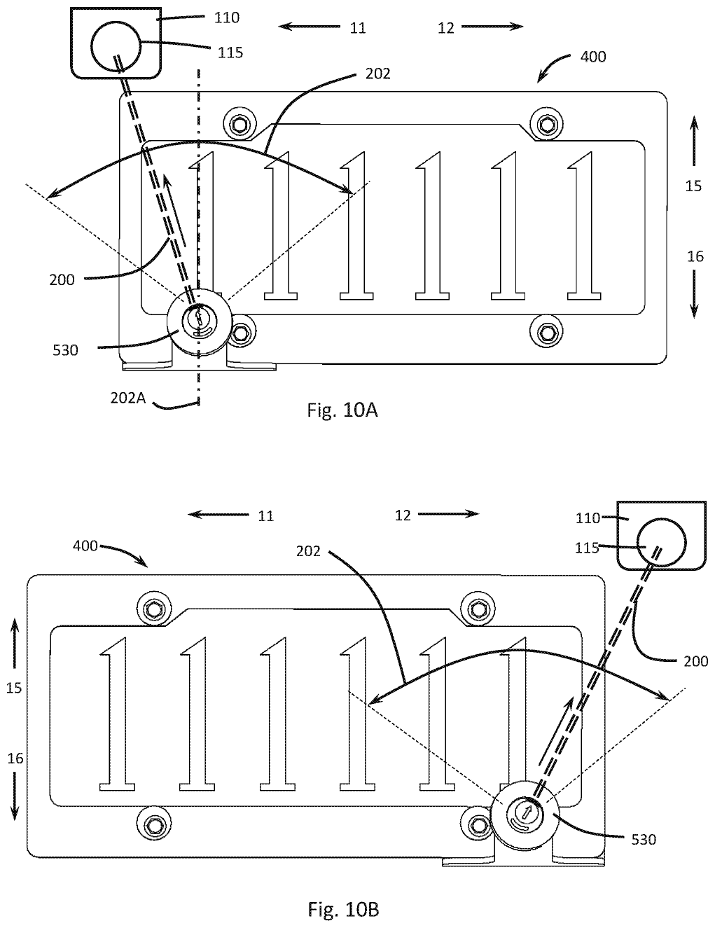

FIG. 10A is a diagrammatic representation of the lens cleaning system 400, with the nozzle assembly 530 positioned in a left-side mounting position. A generally upward direction 15 of the stream or spray of fluid 200 is illustrated, which may be set within a second angular range 202. For the embodiment of the nozzle assembly 530 illustrated, the second angular range 202 is three hundred sixty degrees (a full circle). The position of the camera 110 may vary, depending upon the configuration of the vehicle 100. A minimum second angular range 202 of one hundred twenty degrees may accommodate a wide range of camera 110 positions on the vehicle 100, e.g., with a center of the range being along a vertical axis 202A.

FIG. 10B is a diagrammatic representation of the lens cleaning system 400, with the nozzle assembly 530 in the right-side mounting position, which was discussed as an option when addressing the features illustrated in FIG. 4A, above. The optional mounting positions for the nozzle assembly 530 may allow for a reduced distance between the lens 115 and the nozzle 340, depending upon the position of the camera 110 on the vehicle 100, and thus may reduce the range required for the stream or spray of fluid 200 to effectively clean the lens 115.

As illustrated in FIGS. 10A and 10B, an embodiment of the lens cleaning system 400 may support multiple nozzle 340 positions in order to suitably position the nozzle 340 relative to the camera 110, e.g., due to the nozzle bracket 360 having a plurality of distributed mounting apertures 360A1, 360A2 (FIG. 11D). A nozzle assembly 530 having a first angular range 201 (FIG. 7) as well as a second angular range 202 may allow the lens cleaning system 400 to function with many different models of vehicles 100, for which the location of the camera 110 may vary widely. An advantage offered by such adjustability in aim and positions of the nozzle 340, as illustrated in FIGS. 7, 10A and 10B, is the adaptability of the lens cleaning system 400 to various models of vehicles 100 without the need for complex fixturing schemes for the nozzle 340 or modifications to the vehicle 100.

FIG. 11 is a diagrammatic representation of an embodiment of the nozzle assembly 530, which is directionally adjustable. FIGS. 11A1, 11A2, 11A3 and 11A4 show the sectional view along lines A-A of FIG. 11. FIGS. 11B, 11C and 11D further illustrate certain features of the nozzle assembly 530. FIG. 11E illustrates a stream of fluid 200 impinging onto a lens 115. More about the embodiment of the nozzle assembly 530 illustrated in FIGS. 11 through 11E is provided below.

As shown in FIGS. 11 and 11A1, the nozzle assembly 530 includes a spherical body 510 (though other arcuate outer shapes are within the scope of the disclosure). The spherical body 510 may also be referred to as a spherical member, or a nozzle control member, or a spray directing member. The spherical body 510 defines a first spherical body aperture 510A1 on a spherical body outer surface 510B. A first spherical body passage (or body fluid duct) 510F1 extends from the first spherical body aperture 510A1 radially toward a center 510C of the spherical body 510 along a first spherical body passage axis 510D1 and is fluidly coupled to the nozzle 340.

A second spherical body aperture 510A2 may be defined on the spherical body 510, circumferentially spaced apart from the first spherical body aperture 510A1. A second spherical body passage 510F2 may extend from the second spherical body aperture 510A2 radially toward the center 510C of the spherical body 510 along a second spherical body passage axis 510D2 to fluidly couple with the first spherical body passage 510F1, e.g., at the center 510C of the spherical body 510. In one embodiment, the first and second spherical body passages 510F1, 510F2 are perpendicular to each other. The nozzle 340 is positioned within, or may be formed by, the second spherical body passage 510F2.

A third spherical body aperture 510A3 may be defined on the spherical body 510, circumferentially spaced apart from the first and second spherical body apertures 510A1, 510A2. A third spherical body passage 510F3, also referred to as an aiming pin bore 510F3, may extend from the third spherical body aperture 510A3 radially toward the center 510C of the spherical body 510 along a third spherical body passage axis 510D3. The aiming pin bore 510F3 is radially shallower than the first and second spherical body passages 510F1, 510F2 and therefore fluidly isolated from the first and second spherical body passages 510F1, 510F2 by an interior wall 510E defined therebetween. The aiming pin bore 510F3 is positioned substantially opposite the second spherical body aperture 510A2 for the nozzle 340, as shown. The second and third spherical body passage axes 510D2, 510D3 of the spherical body 510 may be coaxial with each other.

The spherical body 510 may be disposed within a nozzle housing assembly 500. For the embodiment illustrated in FIGS. 11 through 11E, the nozzle housing assembly 500 includes a nozzle housing body 501, a nozzle housing cap 502, and a nozzle housing outer lock ring 503. It is to be appreciated that the nozzle housing assembly 500 may be formed as a unitary member, e.g., by additive manufacturing, welding, or other technique, in which case the nozzle housing assembly 500 could be alternatively referred to as a nozzle housing. A nozzle assembly fastener 520 secures the nozzle housing assembly 500 to the nozzle bracket 360.

As shown in FIG. 11A2, the nozzle housing cap 502 is generally cup shaped or frustoconical shaped. The nozzle housing cap 502 defines a first nozzle housing cap end 502A1 and a second nozzle housing cap end 502A2 that are spaced apart along a nozzle housing cap axis 502B. The second nozzle housing cap end 502A2 may be wider, e.g., having a larger diameter, than the first nozzle housing cap end 502A1 and may be larger than a diameter of the spherical body 510. The nozzle housing cap axis 502B may be coaxial with the first spherical body passage axis 510D1 (FIG. 11A1) in the spherical body 510 when the nozzle assembly 530 is assembled.

A nozzle housing cap outer wall 502C extends between the first and second nozzle housing cap ends 502A1, 502A2 to define the frustoconical shape. The first nozzle housing cap end 502A1 is sealed by a nozzle housing cap end wall 502D. The second nozzle housing cap end 502A2 defines a radially outwardly extending flange (or nozzle housing cap flange) 502E.

A nozzle housing cap outlet aperture 502F1 is defined in the nozzle housing cap outer wall 502C axially between the first and second nozzle housing cap ends 502A1, 502A2 of the nozzle housing cap 502. A nozzle housing cap outlet passage 502G1 extends into the nozzle housing cap outer wall 502C from the nozzle housing cap outlet aperture 502F1. As shown in FIG. 11C, the nozzle housing cap outlet aperture 502F1 may have a non-circular shape, and more specifically a generally rectangular shape (though other shapes such as oval are within the scope of the disclosure), that is sufficiently large to allow a large targeting exit area for an adjustable nozzle 340 spray direction when the spherical body 510 is seated within the nozzle housing assembly 500 and is rotated for aiming the nozzle 340 (as shown in FIG. 11A4), and as further explained below.

As shown in FIGS. 11A2 and 11A4, a secondary nozzle housing cap aperture 502F2 may be defined in the nozzle housing cap outer wall 502C, axially aligned with and circumferentially offset from the nozzle housing cap outlet aperture 502F1. A secondary nozzle housing cap passage 502G2 may extend into the nozzle housing cap outer wall 502C from the secondary nozzle housing cap aperture 502F2. This is for inserting an aiming pin tool 526 into the aiming pin bore 510F3 of the spherical body 510 when the spherical body 510 is seated within the nozzle housing assembly 500. The secondary nozzle housing cap aperture 502F2 may have a non-circular shape, and more specifically a generally rectangular shape (though other shapes such as oval are within the scope of the disclosure), that is sufficiently large to allow the adjustment in the direction of the nozzle 340 by the aiming pin tool 526 when the spherical body 510 is seated within the nozzle housing assembly 500. Specifically, the first angular range 201 (FIGS. 7 and 11A4) of the stream or spray of fluid 200 may be defined, in part, by the shape and size of the secondary nozzle housing cap aperture 502F2.

In addition, as shown in FIG. 11C, a bottom side 502E1 of the nozzle housing cap flange 502E includes protrusions (or bosses) 502E2 that are circumferentially spaced apart from each other and project along the nozzle housing cap axis 502B. The protrusions 502E2 serve as anti-rotation features as when the nozzle housing cap 502 is seated against the nozzle housing body 501.

As shown in FIG. 11A2, nozzle housing cap bottom aperture 502H is defined in the second nozzle housing cap end 502A2 of the nozzle housing cap 502. A diameter of the nozzle housing cap bottom aperture 502H is smaller than an outer diameter of the nozzle housing cap outer wall 502C and larger than or equal to an outer diameter of the spherical body 510. A nozzle housing cap seating passage 502J in the nozzle housing cap 502 is formed along the nozzle housing cap axis 502B, extending into the nozzle housing cap 502 from the nozzle housing cap bottom aperture 502H toward the first nozzle housing cap end 502A1 to define a nozzle wall thickness along its length, wherein the wall thickness may vary along its length.

The nozzle housing cap seating passage 502J in the nozzle housing cap 502 extends long enough so that when the spherical body 510 is seated therein, the second spherical body passage 510F2 for the nozzle 340 of the spherical body 510 is axially aligned with the nozzle housing cap outlet aperture 502F1, and the aiming pin bore 510F3 of the spherical body 510 is axially aligned with the secondary nozzle housing cap aperture 502F2 to enable both spraying of fluid and control of the spherical body 510 for directing the spraying of fluid. A top internal end 502K of the nozzle housing cap seating passage 502J may be hemispherical shaped to allow rotation of the spherical body 510 against it.

As shown in FIG. 11A3, the nozzle housing body 501 defines a plurality of nozzle housing body segments generally referenced as 501A, including a first nozzle housing body segment 501A1, a second nozzle housing body segment 501A2, a third nozzle housing body segment 501A3, and a fourth nozzle housing body segment 501A4, that are successively adjacent along a nozzle housing body axis 501B. The nozzle housing body axis 501B is along the first spherical body passage axis 510D1 (FIG. 11A1).

The spherical body 510 is supported at a first axial outer end 501C (or axial top end) of the first nozzle housing body segment 501A1. Thus, the first axial outer end 501C of the first nozzle housing body segment 501A1 has an arcuate profile that enables seating and rotation of the spherical body 510 against it.

The second nozzle housing body segment 501A2 has a larger diameter than the first nozzle housing body segment 501A1 to define a nozzle housing body platform 501D, which is used for receiving the nozzle housing cap flange 502E of the nozzle housing cap 502. The second nozzle housing body segment 501A2 has a diameter that is as large (or larger) than the diameter of the nozzle housing cap flange 502E.

As shown in FIG. 11B, a plurality of nozzle housing body grooves 501E are formed into the nozzle housing body platform 501D, for receiving the protrusions (or bosses) 502E2 (FIG. 11C) of the nozzle housing cap 502 to provide for an anti-rotation connection between the nozzle housing cap 502 and the nozzle housing body 501. The nozzle housing body grooves 501E and the protrusions (or bosses) 502E2 are collectively referred to herein as interlock features 540.

Referring back to FIG. 11A3, the second nozzle housing body segment 501A2 defines an axially extending, radial outer second nozzle housing body segment wall 501F that includes an externally threaded surface 501F1 to engage the nozzle housing outer lock ring 503. The second nozzle housing body segment 501A2 is long enough to provide for locking engagement with the nozzle housing outer lock ring 503.

The third nozzle housing body segment 501A3 defines an axially extending, radial outer third nozzle housing body segment wall 501G that includes an externally threaded surface 501G1 to engage the nozzle assembly fastener 520 through the nozzle bracket 360.

The fourth nozzle housing body segment 501A4 defines an axially extending, radial outer fourth nozzle housing body segment wall 501H that is configured to engage an end of the flexible fluid tubing 345. The fourth nozzle housing body segment 501A4 may have a barbed outer surface 501H1 for engaging the fluid tubing 345.

The nozzle housing body 501 defines a nozzle housing body axial top aperture 501K centered on the nozzle housing body axis 501B, and a nozzle housing body bottom aperture 501L, which may also be centered on the nozzle housing body axis 501B. A nozzle housing body passage 501M, formed in the nozzle housing body 501, extends between the nozzle housing body axial top aperture 501K and the nozzle housing body bottom aperture 501L. With this configuration, the nozzle housing body passage 501M is fluidly coupled with the first spherical body passage 510F1 when the nozzle housing body axis 501B is aligned with the first spherical body passage axis 510D1 (FIG. 11A1).

The nozzle housing body passage 501M receives wash fluid 215 via the nozzle housing body bottom aperture 501L, which is directed into the nozzle housing body passage 501M for transporting wash fluid 215 from the nozzle housing body bottom aperture 501L to the nozzle housing body axial top aperture 501K, which is fluidly coupled to the first spherical body aperture 510A1.

The nozzle housing outer lock ring 503 is generally cup-shaped having a radial base portion 503A and an axially extending outer wall portion 503B that extends axially downwardly from the radial base portion 503A. The radial base portion 503A defines a nozzle housing outer lock ring aperture 503C so that the nozzle housing outer lock ring 503 may be positioned over the nozzle housing cap 502 to engage the nozzle housing cap flange 502E without frictionally engaging the nozzle housing cap outer wall 502C. The axially extending outer wall portion 503B of the nozzle housing outer lock ring 503 includes an internally threaded surface 503D to engage the externally threaded surface 501F1 of the second nozzle housing body segment 501A2.

For the embodiment of the nozzle assembly 530 illustrated in FIG. 11A3, as the nozzle housing outer lock ring 503 is turned (i.e. tightened) relative to the nozzle housing body 501, the nozzle housing assembly 500 is configured to compress the spherical body 510 against the nozzle housing body 501 so that a nozzle fluid seal 511 is formed around the fluid coupling jointly defined by the first spherical body aperture 510A1 and the nozzle housing body axial top aperture 501K. A nozzle housing gap 541, which may be one (1) to three (3) millimeters for example, may enable adequate contact pressure at the nozzle fluid seal 511 when the nozzle housing outer lock ring 503 is turned (i.e. tightened). This configuration also fluidly couples therethrough the nozzle 340 and thereby allows a flow of wash fluid 215 to pass through the nozzle assembly 530.

As shown in FIG. 11A4, the nozzle housing assembly 500, via the secondary nozzle housing cap passage 502G2 proximate the aiming pin bore 510F3, is configured to allow a shaft (or pin) 526A of the aiming pin tool 526 to enter into the aiming pin bore 510F3 of the spherical body 510. The aiming pin tool 526 may be inserted into the aiming pin bore 510F3 to enable the rotation of the spherical body 510 about the center 510C of the spherical body 510 and within the nozzle housing assembly 500 in order to adjust the aim of the nozzle 340 within the first angular range 201 and within a portion of the second angular range 202 (FIG. 10A) so that the nozzle 340 may direct the stream or spray of fluid 200 at the lens 115. The limits for the rotation of the spherical body 510, when seated within the nozzle housing assembly 500 and when the aiming pin tool 526 is inserted into the aiming pin bore 510F3, may be set by the size and shape of the secondary nozzle housing cap aperture 502F2, as explained below.

As shown in FIG. 11A4, the nozzle housing assembly 500 may be configured such that the fluid coupling between first spherical body aperture 510A1 and the nozzle housing body axial top aperture 501K is maintained, allowing wash fluid 215 to pass, such as when the aiming pin tool 526 is inserted into the aiming pin bore 510F3 and moved in a direction that is perpendicular to the shaft (or pin) 526A (for example, in the direction toward the bracket as illustrated) such that the shaft (or pin) 526A contacts the nozzle housing cap outer wall 502C, for example, along a bottom edge 502L of the secondary nozzle housing cap aperture 502F2. In such circumstance, the first spherical body aperture 510A1 is no longer concentric with the nozzle housing body axial top aperture 501K, but the fluid coupling may be maintained as illustrated. Thus, interference between the shaft (or pin) 526A of the aiming pin tool 526 and the nozzle housing cap outer wall 502C at the secondary nozzle housing cap aperture 502F2 may limit the rotation of the spherical body 510 when seated in the nozzle housing assembly 500, and may also ensure that fluid communication within the nozzle assembly 530 is maintained.

Such shaft (or pin) 526A interference with the bottom edge 502L or a top edge 502M of the secondary nozzle housing cap aperture 502F2 may set the limits for the first angular range 201 of the stream or spray of fluid 200, as indicated in FIG. 11A4. Such shaft (or pin) 526A interference with a first or second side edge 502N, 502P (FIG. 11) of the secondary nozzle housing cap aperture 502F2 may set limits within a portion of the second angular range 202 (FIG. 10A) of the stream or spray of fluid 200, such as when the nozzle housing assembly 500 is secured (i.e. fixed) to the nozzle bracket 360. The limits of the portion of the second angular range 202 described above may be exceeded by repositioning (i.e. turning) the nozzle housing assembly 500 within the bracket 360 (as described in more detail below), which may enable a three hundred sixty degree (360) (i.e. a full circle) angular range for the second angular range 202 of the stream or spray of fluid 200.

As shown in FIG. 11A4, the nozzle assembly 530 includes the nozzle assembly fastener 520, which may secure the nozzle housing assembly 500 to the nozzle bracket 360 via an internally threaded surface 520A of the nozzle assembly fastener 520, which engages the externally threaded surface 501G1 of the third nozzle housing body segment 501A3.

For the embodiment of the nozzle assembly 530 illustrated in FIGS. 11 through 11E, the nozzle 340, formed by the second spherical body passage 510F2, that is cylindrical in shape, is configured to produce a substantially solid stream of fluid 200 during the operation of the lens cleaning system 400. Other nozzle 340 shapes, which may produce other stream or spray 200 patterns, may be suitable for the lens cleaning system 400 and are within the scope of the disclosure.

As described above, the nozzle assembly 530 may include interlock features 540 on the mating surfaces of the nozzle housing body 501 and the nozzle housing cap 502. FIGS. 11B and 11C illustrate perspective views of interlock features 540 on embodiments of the nozzle housing body 501 and nozzle housing cap 502. The interlock features 540 are intended to prevent relative rotation between the nozzle housing body 501 and the nozzle housing cap 502 while the nozzle housing outer lock ring 503 is engaged (i.e. tightened) onto the nozzle housing body 501 for creating the fluid seal 511. Such relative rotation could unintentionally change the aim of the nozzle 340 during the installation of the lens cleaning system 400.

FIG. 11D illustrates an exploded detail of an embodiment of the nozzle assembly 530. For assembly and installation of the nozzle assembly 530, the nozzle housing body 501 may be initially positioned into a nozzle housing receiving aperture 363 in the nozzle bracket 360, and then secured to the nozzle bracket 360 using the nozzle assembly fastener 520. Wash fluid 215 is communicated between the pump 305 and the nozzle housing body 501 via the fluid tubing 345 (FIG. 11E), which passes through a fluid tubing aperture 364 (FIGS. 11D and 11E) of the nozzle bracket 360. The nozzle housing cap 502, with the spherical body 510 disposed interiorly of the nozzle housing cap 502, may then be positioned onto the nozzle housing body 501, axially aligned as described above and as illustrated in FIG. 11A1. The nozzle housing outer lock ring 503 may then be installed onto both the nozzle housing cap 502 and the nozzle housing body 501, and then fully turned (i.e. tightened) to compress the spherical body 510 between the nozzle housing cap 502 and the nozzle housing body 501, creating the nozzle fluid seal 511 (FIG. 11A3). The general aim of the nozzle 340 within the second angular range 202 may be adjusted by loosening the nozzle assembly fastener 520, and then by rotating the nozzle assembly 530 within the nozzle housing receiving aperture 363 of the nozzle bracket 360 to a desired orientation, whereas the aim of the nozzle 340 is generally pointed toward the lens 115. The nozzle assembly fastener 520 may then be re-tightened to secure the nozzle assembly 530 to the nozzle bracket 360.

The final directional adjustment of the nozzle 340 may be performed by initially inserting the aiming pin tool 526 into the aiming pin bore 510F3. FIG. 11E illustrates an embodiment of the lens cleaning system 400 and the insertion of the aiming pin tool 526 into the aiming pin bore 510F3 and the movement of the aiming pin tool 526 to enable the rotation of the spherical body 510, such that the stream or spray of fluid 200 may be directed within the first angular range 201 and a portion of the second angular range 202, and may impinge on the lens 115 as shown. The aiming pin tool 526 may then be removed from the aiming pin bore 510F3.

An advantage of the above embodiment of the nozzle assembly 530, which is directionally adjustable while wash fluid 215 is flowing, is that it may facilitate the directing of the stream or spray of fluid 200 while avoiding a series of trial and error adjustments. This may enable a convenient installation of the lens cleaning system 400 for the user. The above embodiment of the nozzle assembly 530 may also be resistant to an accidental change in the aim of the nozzle 340 after installation of the lens cleaning system 400 because the nozzle 340 is housed within and protected by the nozzle housing assembly 500. Such a protective feature, e.g., the nozzle housing assembly 500, may be useful for preserving the intended aim of the nozzle 340 during an automatic car wash of the vehicle 100, where large rotating brushes may strike the nozzle assembly 530.

Further Detail of the Fluid System Operation

Fluid system features of the disclosed embodiments will now be provided in further detail. A small amount of wash fluid 215 may be effective in removing foreign matter from the lens 115 of a camera 110. For example, approximately three (3) milliliters, or a stream or spray of fluid 200 flowing at approximately three hundred (300) milliliters per minute and lasting approximately six tenths (0.6) of a second, may effectively clean a lens 115 having a diameter of approximately twelve (12) millimeters. Several factors, including the fluid pressure generated by the pump 305, which may be in the range of fifteen (15) to twenty (20) pounds per square inch (psi), and the diameter of the nozzle 340, which may be less than one (1) millimeter (mm), may influence the flow rate and useful range of the stream or spray of fluid 200. It should be noted that a flow rate in the range of two hundred (200) to three hundred (300) milliliters per minute, and a duration of flow in the range of one-half (0.5) to one (1) second, are identified herein, though other flow rates and durations are within the scope of the disclosure. The volumetric capacity of the fluid container 330 may influence the capacity for the number of lens 115 cleanings between refills of the fluid container 330. The lens cleaning system 400 may be configured for a high fluid capacity, over four hundred (400) milliliters for example, using an unpressurized fluid container 330 that is shaped to conform to the available storage volume 354. Such a configuration may result in a capacity, for example, for up to two hundred fifty (250) cleanings of the lens 115 between refills of the fluid container 330.

Referring back to FIG. 5, an embodiment of the fluid container 330 may include the filler port 390 for conveniently refilling the fluid container 330 with wash fluid 215. The filler port 390 may be covered by a cap to contain the wash fluid 215. A level of wash fluid 215 within the fluid container 330, which may be transparent or semitransparent, may be visually observed on the side of the lens cleaning system 400. This visual indication may be useful when filling the fluid container 330 through the filler port 390.

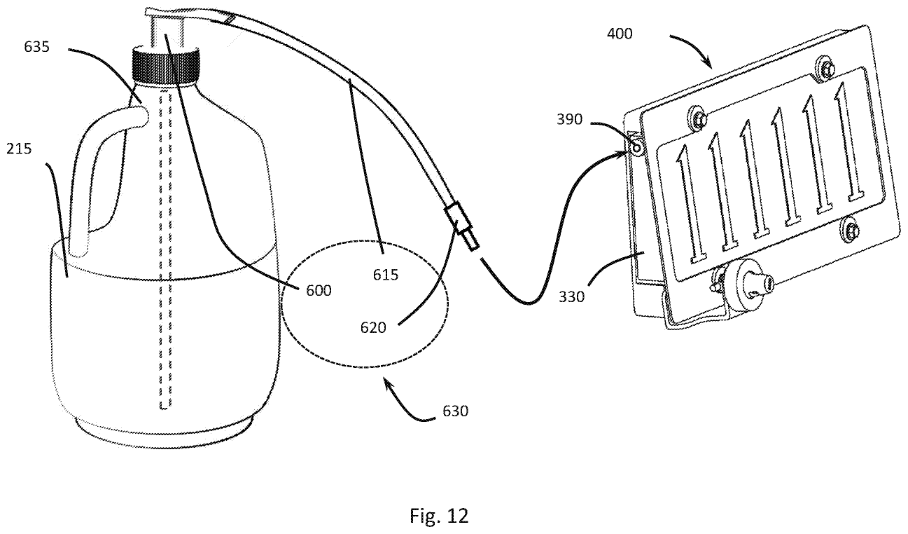

FIG. 12 illustrates an embodiment of a fluid filler tool assembly 630 that includes a filler pump 600, a filler tube 615 fluidly coupled at one end of the filter tube 615 to the filler pump 600, and a filler port fitting 620 fluidly coupled to another end of the filler tube 615. As illustrated, the fluid container 330 may be filled with wash fluid 215 from a bottle 635 by inserting the filler port fitting 620 into the filler port 390. A few pumps, by hand, of the filler pump 600 may relatively easily and conveniently fill the fluid container 330.

The lens cleaning system 400 may contain features that prevent or limit leakage of the wash fluid 215 when the pump 305 is not in operation. Turning back to FIG. 4B, an embodiment of the lens cleaning system 400 may incorporate the nozzle check valve 380, or similar feature. As illustrated in FIG. 5, the lens cleaning system 400 may include the fluid container 330 that is filled with wash fluid 215 and positioned vertically higher than the nozzle assembly 530. Without a suitable nozzle check valve 380, the above arrangement may result in a pressure level (i.e. static pressure head) in the wash fluid 215 located within the nozzle assembly 530 that causes leakage of the wash fluid 215 from the nozzle 340 when the pump 305 is not operating. Such leakage may eventually drain the wash fluid 215 from the fluid container 330.

The nozzle check valve 380, configured with a cracking pressure that exceeds a static pressure head at the inlet of the nozzle check valve 380, may be incorporated into the lens cleaning system 400 in order to prevent such leakage of the wash fluid 215. Cracking pressure is the minimum differential upstream pressure between the inlet and outlet of a check valve, at which a check valve will open. An embodiment of the nozzle check valve 380 of the lens cleaning system 400 illustrated in FIG. 5 may be configured to have a cracking pressure of approximately one-half (0.5) psi, though other cracking pressures are within the scope of the disclosure. Such a cracking pressure may provide adequate margin to the static pressure head at the inlet of the nozzle check valve 380 to prevent wash fluid 215 leakage, and may also be low enough to ensure that the pump 305 can self-prime with wash fluid 215 during the initial installation and setup of the lens cleaning system 400. Some embodiments of the lens cleaning system 400 may not require a nozzle check valve 380, depending upon the physical arrangement of the lens cleaning system 400 and the configuration of the pump 305.

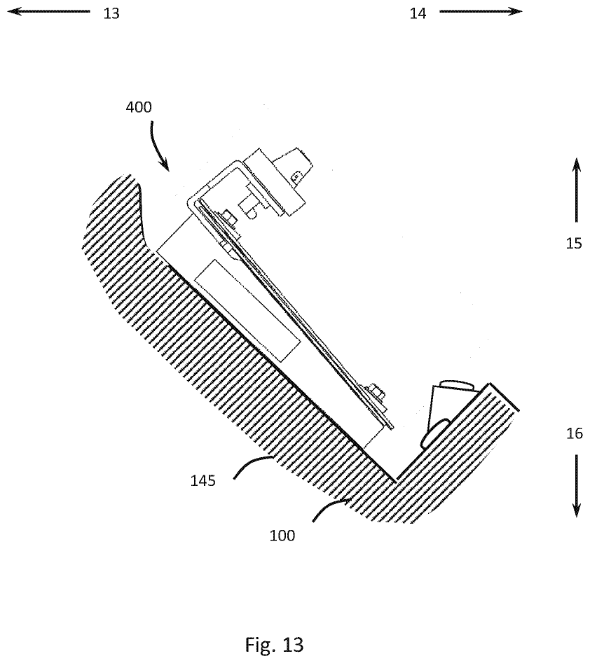

The lens cleaning system 400 may also contain features that prevent or limit leakage of the wash fluid 215 when the lens cleaning system 400 is partially inverted, such as when the trunk or lift gate 145 of the vehicle 100 is raised. Referring again back to FIG. 4B, an embodiment of the fluid container 330 may incorporate the fluid container check valve 385. The fluid container check valve 385 is intended to maintain ambient pressure within the internal chamber 332 of the fluid container 330 by opening to allow air to enter the internal chamber 332, thereby preventing the formation of vacuum pressure within the internal chamber 332 when the wash fluid 215 is drawn away by the pump 305 for cleaning the lens 115. The fluid container check valve 385 may permit fluid or air flow in one direction only, which is into the internal chamber 332 of the fluid container 330. Therefore, the fluid container check valve 385 may also prevent wash fluid 215 from leaking externally when the trunk or lift gate 145 of the vehicle 100 is raised, causing the lens cleaning system 400 to be partially inverted as illustrated in FIG. 13. Under this circumstance of lens cleaning system 400 inversion, the fluid container check valve 385 may remain closed, while preventing the leakage of the wash fluid 215. A suitable cracking pressure for the fluid container check valve 385 may be approximately one-tenth (0.1) psi, though other cracking pressures are within the scope of the disclosure. It should be noted that an embodiment of the lens cleaning system 400 may be configured to maintain ambient pressure within the internal chamber 332 of the fluid container 330 by including the fluid container aperture 333, which may be a pin-hole fluid container aperture 333 with a diameter of one (1) millimeter for example, without including the fluid container check valve 385. In such an embodiment of the lens cleaning system 400, the inclusion of the nozzle check valve 380 may limit or reduce leakage of wash fluid 215 through the fluid container aperture 333 during lens cleaning system 400 inversion.

### Description of Alternative Embodiments

A description of alternate embodiments of the lens cleaning system 400 is included below, with references to accompanying drawings. Certain parts and features of the lens cleaning system 400 having like reference numbers to features identified above, such as in FIGS. 3A and 3B, shall be construed the same and shall be construed to have the same mating components and connections to such components unless otherwise disclosed below.

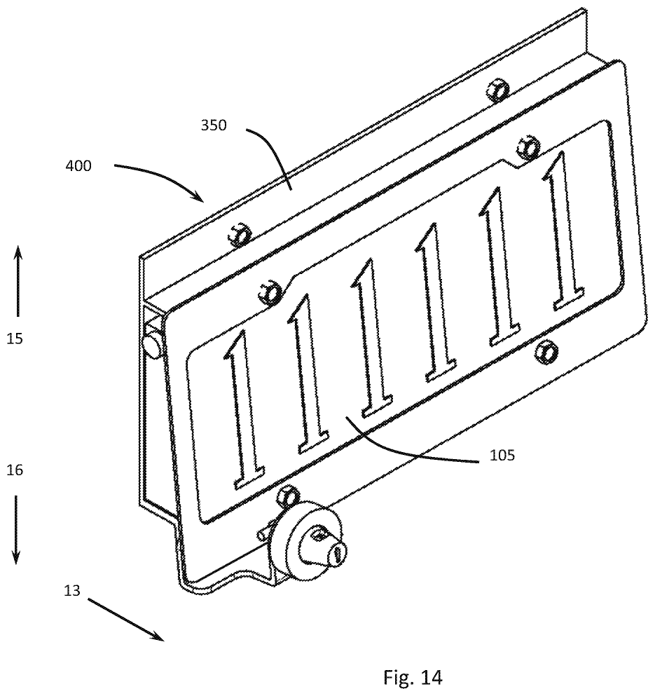

FIG. 14 is a perspective view of an embodiment of the lens cleaning system 400 featuring the frame 350 that is configured to reposition the license plate 105 in the rearward direction 13 and the vertically downward direction 16, in comparison with the second-original license plate 105 position as illustrated in FIG. 2B. The benefits of such an embodiment of the lens cleaning system 400 are described herein.

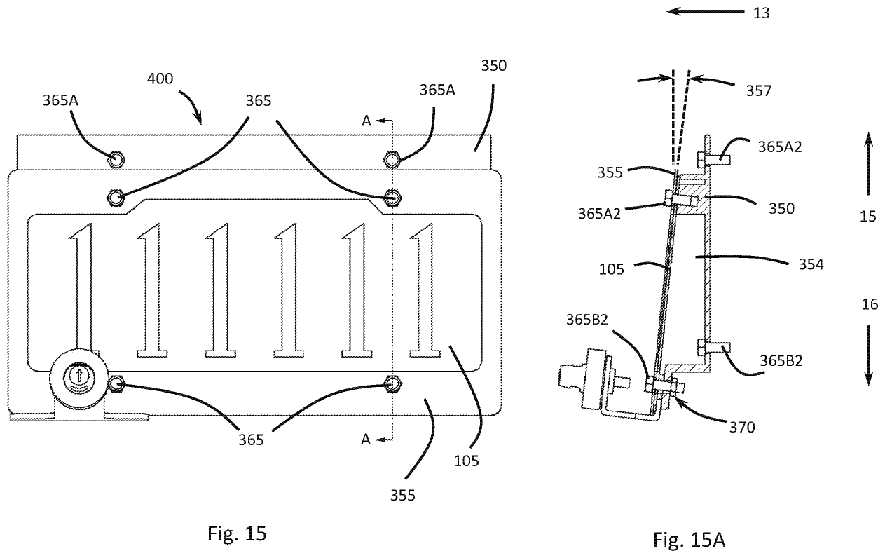

FIG. 15 is a diagrammatic representation of an embodiment of the lens cleaning system 400 as illustrated in FIG. 14. FIG. 15A is the sectional view A-A as indicated in FIG. 15, illustrating the storage volume 354 formed by repositioning the license plate 105. The license plate 105 may be in a rotated position as indicated by angle 357, which may be an acute angle. The lens cleaning system 400 may be mounted to the vehicle 100 using the first and second upper mounting features 365A1, 365A2, which may be combined with first and second lower mounting features 365B1, 365B2, and the license plate mounting apertures 111 of vehicle 100. An advantage of this embodiment of the lens cleaning system 400 is that it may also be secured to the vehicle 100 using headed fasteners (i.e. nuts), for the vehicle 100 that incorporates threaded license plate mounting studs instead of license plate mounting apertures 111. First through fourth mounting features 365A1, 365A2, 365B1, 365B2, and first and second nuts 370A1, 370A2 (shown as nuts 370), are utilized to secure the license plate 105 and the license plate border cover 355 to the frame 350, lowered in the vertical direction 16 to the vertically offset position.

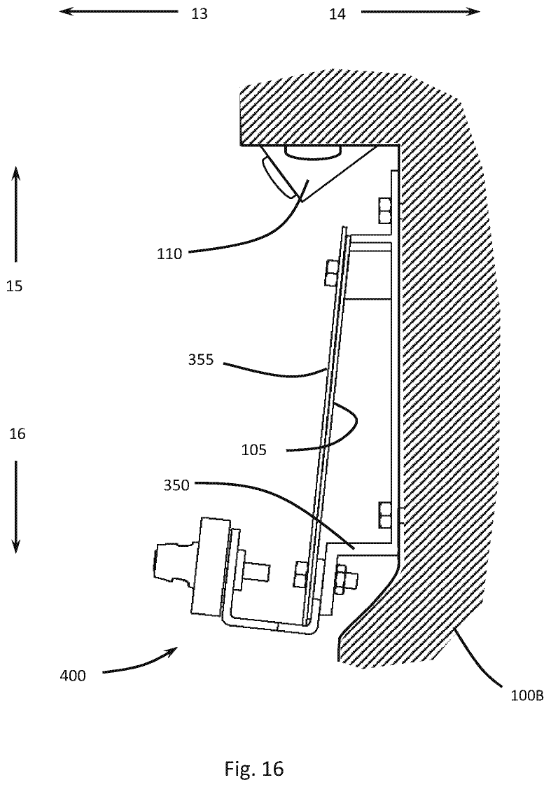

FIG. 16 is a side view of the embodiment of the lens cleaning system 400 illustrated in FIGS. 14, 15, and 15A, and installed onto the vehicle 100B having the camera 110 positioned near to the second-original license plate 105 position, as illustrated in FIG. 2B. The frame 350 may be configured to reposition the license plate 105 in the vertically downward direction 16 relative to the second-original license plate 105 position, so that the lens cleaning system 400 may not interfere with (i.e. contact) the camera 110. Thus, an advantage of this embodiment of the lens cleaning system 400 is that it may be installed onto the second vehicle 100B. In comparison, an embodiment of the lens cleaning system 400 which is not configured to reposition the license plate 105 in the vertically downward direction 16 may not fit onto the second vehicle 100B due to lens cleaning system 400 interference with the camera 110.

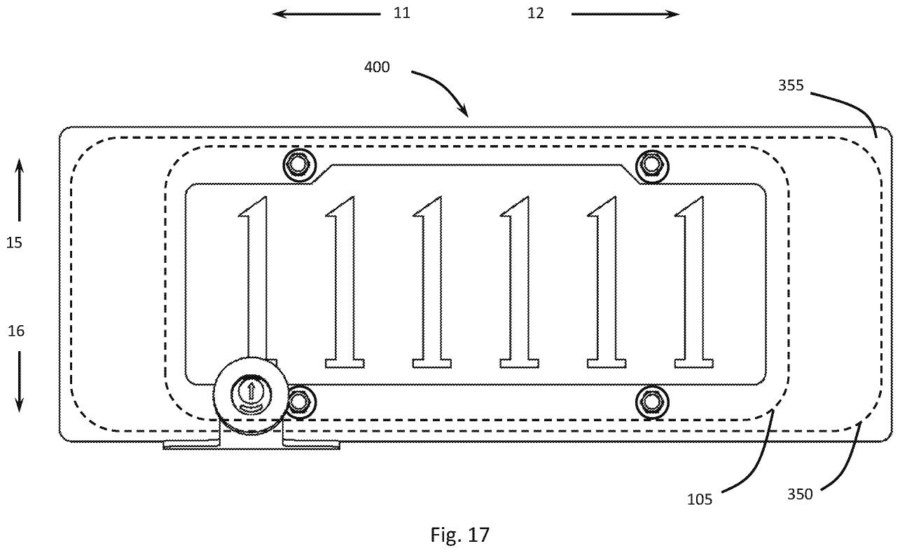

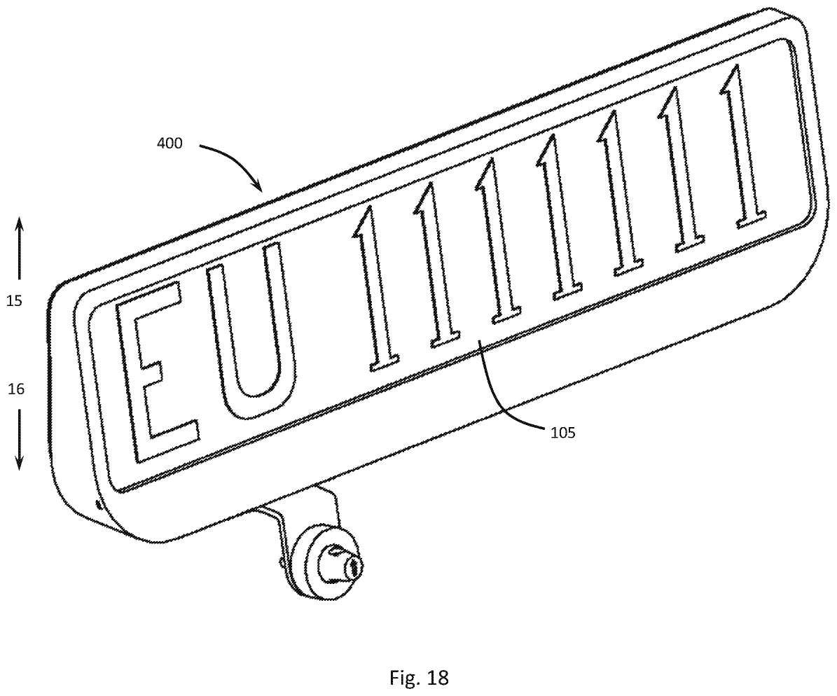

FIG. 17 is a diagrammatic representation of an embodiment of the lens cleaning system 400 which is configured for a greater storage volume 354 within the frame 350, in comparison to the embodiments illustrated in FIGS. 6 and 15. For this embodiment, as illustrated in FIG. 17, the frame 350 and the license plate border cover 355 are larger horizontally in both left 11 and right 12 directions, beyond the edges of the license plate 105. Many of the embodiments of the lens cleaning system 400 disclosed herein may be configured with a larger frame 350 than the license plate 105 to increase the storage volume 354 of the fluid container 330 supported by the frame 350. That is, an advantage of this embodiment of a lens cleaning system 400 is that it may provide greater fluid 215 capacity through a larger fluid container 330, and greater electrical capacity through a larger power supply 335, in comparison to the embodiments as illustrated in FIGS. 6 and 15.

FIG. 18 is a perspective view of an embodiment of the lens cleaning system 400 that is configured to be mounted to different vehicles 100 that may provide several different positions or patterns for license plate mounting apertures 111 for the license plate 105. This embodiment of the lens cleaning system 400 is also suitable for a license plate 105 that does not incorporate mounting holes. More about the embodiment illustrated in FIG. 18 is provided below.

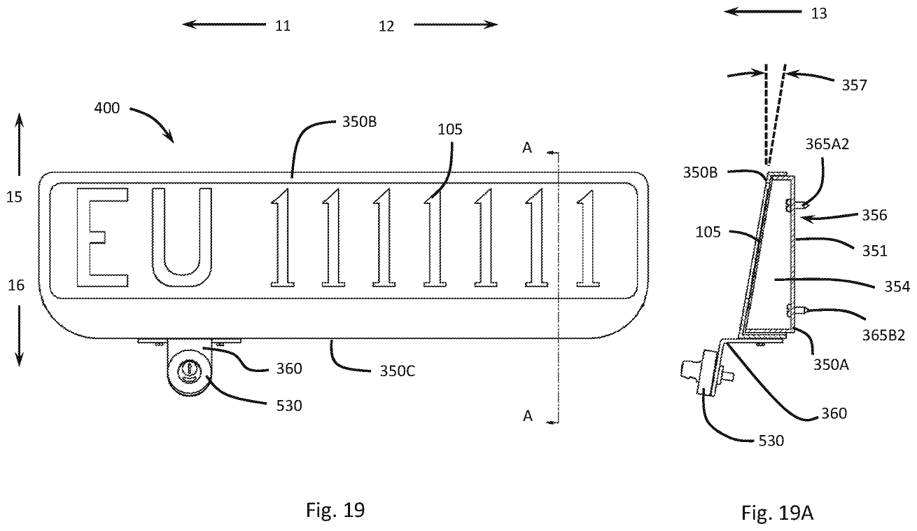

FIG. 19 is the diagrammatic representation of an embodiment of the lens cleaning system 400 as illustrated in FIG. 18. The nozzle assembly 530 and nozzle bracket 360 may be mounted to a front frame 350B at one of several different positions, from the left direction 11 to the right direction 12, along the bottom surface 350C of the front frame 350B. FIG. 19A is a sectional view A-A as shown in FIG. 19, illustrating the storage volume 354 formed between the front frame 350B that supports the license plate 105, and the back frame 350A. The fluid container 330, the pump 305, and the controller 325 may be positioned within the storage volume 354. Additionally, the license plate 105 may be secured at the angle 357, which may be an acute angle, relative to the back surface 351 of the back frame 350A. The back surface 351 of the back frame 350A may include various holes and slots 356 at various locations in order to accommodate a wide variety of vehicle mounting points for mounting features 365A and 365B, which may be bolts or screws. Additionally, the back frame 350A may be configured to attach directly to the nozzle bracket 360.

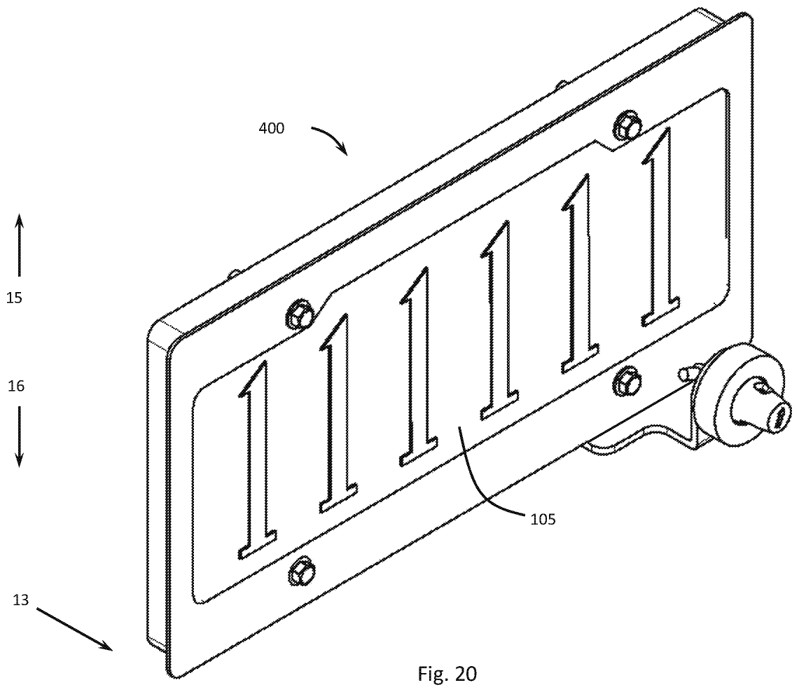

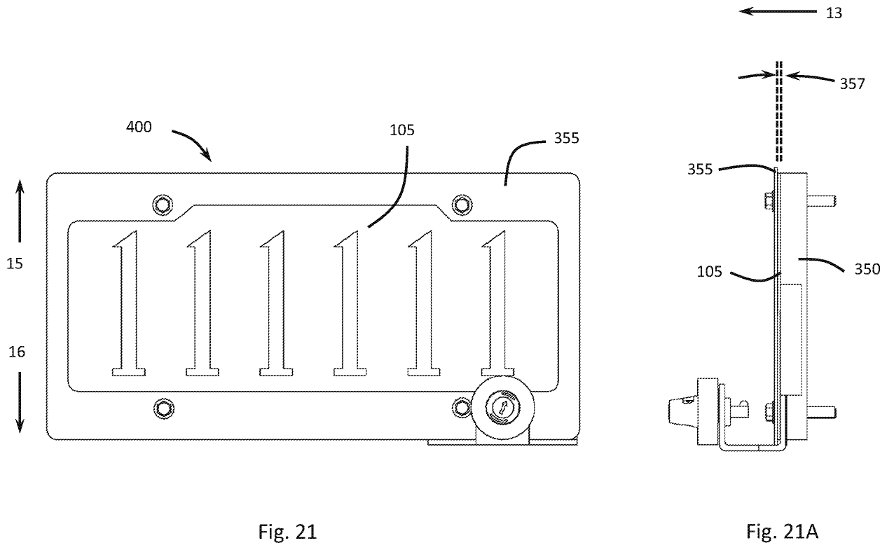

FIGS. 20, 21, and 21A are perspective, front and side views that illustrate an embodiment of the lens cleaning system 400 having the frame 350 that is configured to reposition the vehicle license plate 105 in a rearward direction 13 when mounted to the vehicle 100A (e.g., as shown in FIG. 2A), relative to the first-original position of the license plate 105 on the first vehicle 100A of FIG. 2A. The license plate 105 is secured to the frame 350 at the angle 357 of zero, that is, it is configured to be positioned along a vertical plane, or to be parallel to a mounting portion of the vehicle 100A. This embodiment of lens cleaning system 400 may include a smaller storage volume 354 in comparison to an embodiment of the lens cleaning system 400 that includes the trapezoidal cross section 354.

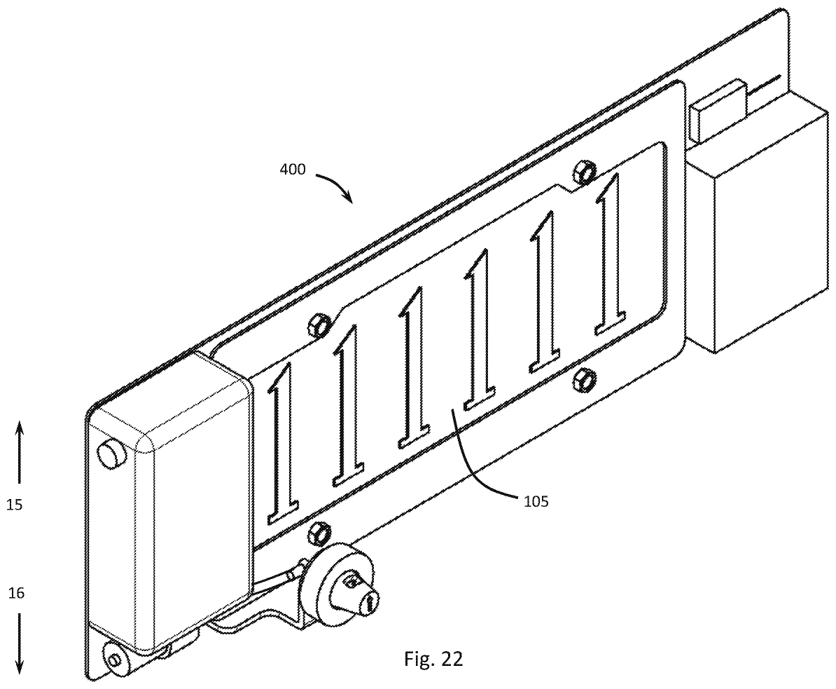

FIG. 22 is a perspective view of an embodiment of the lens cleaning system 400 that does not include the storage volume 354 for positioning some of the components of the system, such as the fluid container 330 or the pump 305. More about the embodiment illustrated in FIG. 22 is provided below.

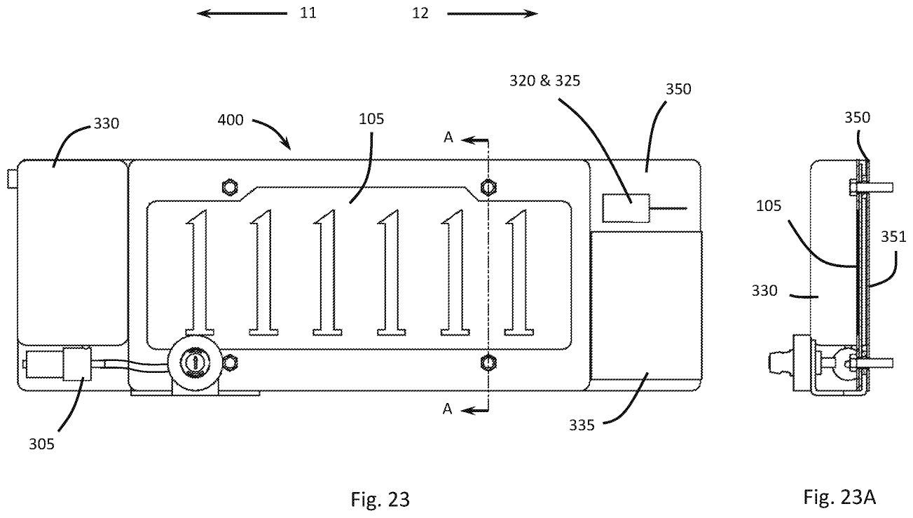

FIGS. 23 and 23A are diagrammatic representations of an embodiment of the lens cleaning system 400 as illustrated in FIG. 22. FIG. 23A is the sectional view A-A of FIG. 23. This embodiment of the lens cleaning system 400 is configured to position some components, such as the fluid container 330, the pump 305, the receiver 320 and the controller 325, and the power supply 335, to the left and right sides of the vehicle license plate 105 when mounted to the vehicle 100. This embodiment of the lens cleaning system 400 requires the license plate mounting surface 147 on the trunk or lift gate 145 of the vehicle 100 to be adequately sized for mounting the back surface 351 of the frame 350 onto the vehicle 100. An advantage of such an embodiment is that greater clearance between the lens cleaning system 400 and the camera 110 on the vehicle 100 may be achieved in comparison to other embodiments described herein.

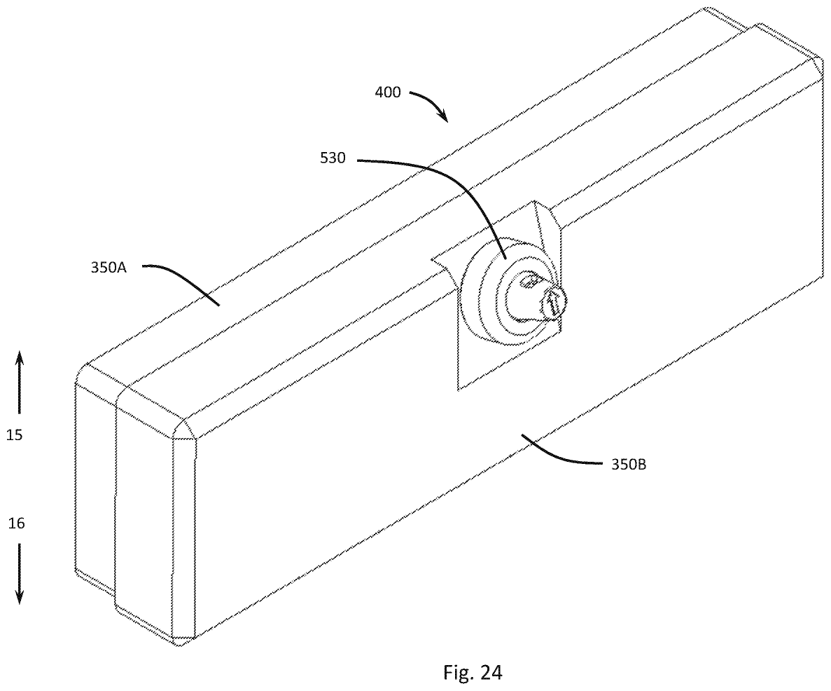

FIG. 24 is a perspective view of an embodiment of the lens cleaning system 400 that is configured to be mounted to an exterior surface of a vehicle 100C (FIG. 1C), such as to the tailgate 148. This embodiment of the lens cleaning system 400, as illustrated, is not configured to seat the license plate 105. This embodiment of the lens cleaning system 400 includes the back frame 350A that may be seated to the tailgate 148 of the third vehicle 100C using mounting features that may be bolts, screws, adhesive, rare earth magnets, or other fixturing means. The front frame 350B may be included to cover some components of the lens cleaning system 400, such as the fluid container 330, the pump 305, and the controller 325. The nozzle assembly 530 may be secured directly to the front frame 350B as illustrated, or to the back frame 350A using the nozzle bracket 360. An advantage of such an embodiment may be the adaptability to the third vehicle 100C which may not easily accommodate the installation of a lens cleaning system 400 onto the license plate mounting surface 147 (FIG. 1C) of the third vehicle 100C due to geometric constraints of the vehicle 100C. Another advantage of such an embodiment may be the ability to position the nozzle assembly 530 in closer proximity to the camera 110, which may be located in the tailgate latch 149 assembly (FIG. 1C), in comparison to an embodiment of the lens cleaning system 400 that is secured to the license plate mounting surface 147 of the third vehicle 100C.

Method

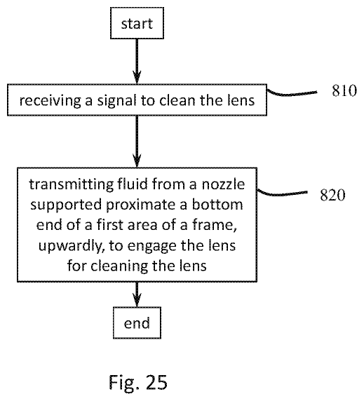

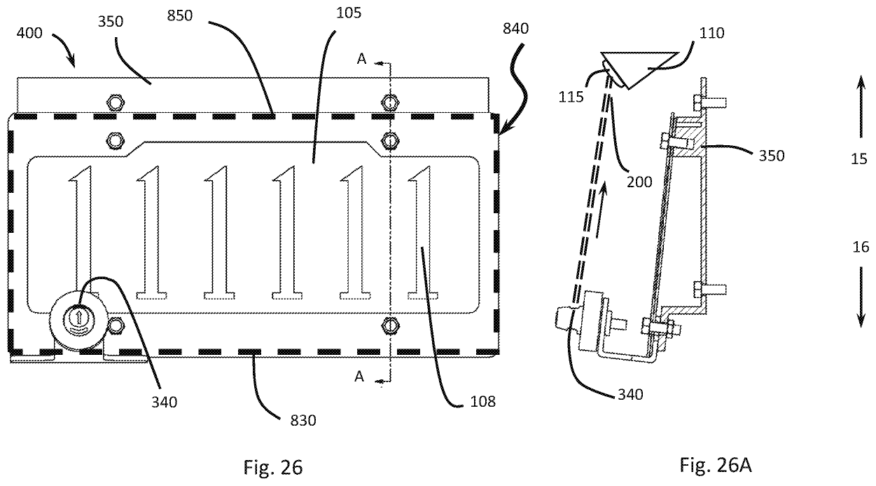

FIG. 25 is a flow chart illustrating a method of cleaning the lens 115 according to an embodiment. FIGS. 26 and 26A are configured to execute the method of FIG. 25. FIG. 26A is the sectional view A-A of FIG. 26, and also illustrates the camera 110. As illustrated in block 810 of FIG. 25, the method includes receiving a signal to clean the lens 115, for example, by the receiver 320 from the transmitter 315. As illustrated in block 820 of FIG. 25, as well as shown in FIGS. 26 and 26A, the method further includes distributing the stream or spray of fluid 200 from the nozzle 340, supported proximate a bottom end 830 of a first area 840 of the frame 350, upwardly, to engage the lens 115 for cleaning the lens 115. As shown in FIG. 26, the first area 840 of the frame 350 is configured for supporting the license plate 105 so that license plate indicia 108 is displayed between a top end 850 and the bottom end 830 of the first area 840 of the frame 350.

Additional Details

An advantage of embodiments described herein may include a relatively high degree of lens cleaning system 400 adaptability to various vehicle 100 models having a variety of body styles, camera 110 positions and camera 110 body shapes. A further advantage may include relative ease of installation of the lens cleaning system 400, without the need for special skills or complex modifications to the vehicle 100. Such adaptability and ease of installation to the vehicle 100 may be enabled by the position of the nozzle 340 relative to the lens 115, and the configuration of the nozzle assembly 530. As described herein, the nozzle 340 may be positioned proximate to or distant (spaced apart) from the lens 115. The nozzle 340 may also be positioned outside or within the field of view of the camera 110. Further, the nozzle assembly 530 is configured for adjustable aim in order to target a wide range of lens 115 positions for cleaning the lens 115 on the vehicle 100.

The controller identified herein may be an electronic controller including a processor and an associated memory comprising computer-executable instructions that, when executed by the processor, cause the processor to perform various operations. The processor may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be but is not limited to a random access memory (RAM), read only memory (ROM), or other electronic, optical, magnetic or any other computer readable medium.

Wireless connections may apply protocols that include local area network (LAN, or WLAN for wireless LAN) protocols and/or a private area network (PAN) protocols. LAN protocols include WiFi technology, based on the Section 802.11 standards from the Institute of Electrical and Electronics Engineers (IEEE). PAN protocols include, for example, Bluetooth Low Energy (BTLE), which is a wireless technology standard designed and marketed by the Bluetooth Special Interest Group (SIG) for exchanging data over short distances using short-wavelength radio waves. PAN protocols also include Zigbee, a technology based on Section 802.15.4 protocols from the IEEE, representing a suite of high-level communication protocols used to create personal area networks with small, low-power digital radios for low-power low-bandwidth needs. Such protocols also include Z-Wave, which is a wireless communications protocol supported by the Z-Wave Alliance that uses a mesh network, applying low-energy radio waves to communicate between devices such as appliances, allowing for wireless control of the same.

Other applicable protocols include Low Power WAN (LPWAN), which is a wireless wide area network (WAN) designed to allow long-range communications at a low bit rates, to enable end devices to operate for extended periods of time (years) using battery power. Long Range WAN (LoRaWAN) is one type of LPWAN maintained by the LoRa Alliance, and is a media access control (MAC) layer protocol for transferring management and application messages between a network server and application server, respectively. Such wireless connections may also include radio-frequency identification (RFID) technology, used for communicating with an integrated chip (IC), e.g., on an RFID smartcard. In addition, Sub-1 Ghz RF equipment operates in the ISM (industrial, scientific and medical) spectrum bands below Sub 1 Ghz—typically in the 769-935 MHz, 315 Mhz and the 468 Mhz frequency range. This spectrum band below 1 Ghz is particularly useful for RF IOT (internet of things) applications. Other LPWAN-IOT technologies include narrowband internet of things (NB-IOT) and Category M1 internet of things (Cat M1-IOT). Wireless communications for the disclosed systems may include cellular, e.g. 2G/3G/4G (etc.). The above is not intended on limiting the scope of applicable wireless technologies.

Wired connections may include connections (cables/interfaces) under RS (recommended standard)-422, also known as the TIA/EIA-422, which is a technical standard supported by the Telecommunications Industry Association (TIA) and which originated by the Electronic Industries Alliance (EIA) that specifies electrical characteristics of a digital signaling circuit. Wired connections may also include (cables/interfaces) under the RS-232 standard for serial communication transmission of data, which formally defines signals connecting between a DTE (data terminal equipment) such as a computer terminal, and a DCE (data circuit-terminating equipment or data communication equipment), such as a modem. Wired connections may also include connections (cables/interfaces) under the Modbus serial communications protocol, managed by the Modbus Organization. Modbus is a master/slave protocol designed for use with its programmable logic controllers (PLCs) and which is a commonly available means of connecting industrial electronic devices. Wireless connections may also include connectors (cables/interfaces) under the PROFibus (Process Field Bus) standard managed by PROFIBUS & PROFINET International (PI). PROFibus which is a standard for fieldbus communication in automation technology, openly published as part of IEC (International Electrotechnical Commission) 61158. Wired communications may also be over a Controller Area Network (CAN) bus. A CAN is a vehicle bus standard that allow microcontrollers and devices to communicate with each other in applications without a host computer. CAN is a message-based protocol released by the International Organization for Standards (ISO). The above is not intended on limiting the scope of applicable wired technologies.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

Table 1 of Reference Numerals within the Figures

| | |
|---|---|
| 11 | left direction |
| 12 | right direction |
| 13 | rearward direction |
| 14 | forward direction |
| 15 | vertically upward direction |
| 16 | vertically downward direction |
| 100 | vehicle |
| 100A | vehicle A |
| 100B | vehicle B |
| 100C | vehicle C |
| 100D | vehicle D |
| 105 | license plate |
| 106 | top edge of license plate |
| 108 | license plate indicia |
| 110 | camera or image sensor |
| 111 | license plate mounting apertures |
| 111A1 | upper left license plate mounting aperture |
| 111A2 | upper right license plate mounting aperture |
| 111B1 | lower left license plate mounting aperture |
| 111B2 | lower right license plate mounting aperture |
| 115 | lens |
| 116 | exterior convex surface of lens |
| 117 | outer edge of lens |
| 118 | plane of lens |
| 119 | aim angle of nozzle |
| 120 | lateral field of view |
| 125A | first zone for camera position |
| 125B | second zone for camera position |
| 130 | vehicle lamp |
| 135 | range of illumination |
| 140 | vertical field of view |
| 145 | trunk or lift gate |
| 147 | license plate mounting surface |
| 148 | tailgate |
| 149 | tailgate latch |
| 150 | interior video display screen |
| 151 | vehicle trajectory zone guidelines |
| 155 | ground |
| 200 | stream or spray of fluid |
| 201 | first angular range of fluid stream (fore/aft) |
| 202 | second angular range of fluid stream (left/right) |
| 202A | vertical axis of second angular range |
| 215 | wash fluid |
| 305 | pump |
| 315 | transmitter |
| 320 | receiver |
| 321 | sensor |
| 325 | controller |
| 330 | fluid container |
| 331 | container wall |
| 332 | internal chamber of fluid container |
| 333 | fluid container aperture |
| 335 | power supply |
| 340 | nozzle |
| 345 | fluid tubing |
| 345A1 | first adjacent segment of fluid tubing |
| 345A2 | second adjacent segment of fluid tubing |
| 350 | frame |
| 350A | back frame |
| 350B | front frame |

Table 2 of Reference Numerals within the Figures

| | |
|---|---|
| 350C | bottom surface of front frame |
| 351 | back surface of frame |
| 352 | support features |
| 352A1 | upper left support feature |
| 352A2 | upper right support feature |
| 352B1 | lower left support feature |
| 352B2 | lower right support feature |
| 353 | seating surfaces |
| 353A | upper seating surfaces |
| 353B | lower seating surfaces |
| 353A1 | upper left seating surface |
| 353A2 | upper right seating surface |
| 353B1 | lower left seating surface |
| 353B2 | lower right seating surface |
| 354 | storage volume of frame |
| 354A | trapezoidal cross section |
| 354A1 | bottom edge of trapezoidal cross section |
| 354A2 | top edge of trapezoidal cross section |
| 354A3 | back edge of trapezoidal cross section |
| 354A4 | front-angled edge of trapezoidal cross section |
| 354B | reference line |
| 354C | lower half of storage volume of frame |
| 354D | upper half of storage volume of frame |
| 355 | license plate border cover |
| 356 | holes and slots of back frame |
| 357 | angle of license plate |
| 360 | nozzle bracket |
| 360A1 | first mounting aperture of nozzle bracket |
| 360A2 | second mounting aperture of nozzle bracket |
| 360A3 | third mounting aperture of nozzle bracket |
| 363 | nozzle housing receiving aperture of nozzle bracket |
| 364 | fluid tubing aperture of nozzle bracket |
| 365 | mounting features |
| 365A1 | upper left mounting feature |
| 365A2 | upper right mounting feature |
| 365B1 | lower left mounting feature |
| 365B2 | lower right mounting feature |
| 370 | nuts |
| 370A1 | left nut |
| 370A2 | right nut |
| 375 | spacer |
| 380 | nozzle check valve |
| 385 | fluid container check valve |
| 390 | filler port |
| 400 | camera lens cleaning system |
| 500 | nozzle housing assembly or nozzle housing |
| 501 | nozzle housing body |
| 501A | nozzle housing body segments |
| 501A1 | first nozzle housing body segment |
| 501A2 | second nozzle housing body segment |
| 501A3 | third nozzle housing body segment |
| 501A4 | fourth nozzle housing body segment |
| 501B | nozzle housing body axis |
| 501C | first axial outer end or axial top end |
| 501D | nozzle housing body platform |
| 501E | nozzle housing body groove |
| 501F | radial outer second nozzle housing body segment wall |
| 501F1 | externally threaded surface of second nozzle housing body |
| | segment |
| 501G | radial outer third nozzle housing body segment wall |
| 501G1 | externally threaded surface of third nozzle housing body segment |

Table 3 of Reference Numerals within the Figures

| 501H | radial outer fourth nozzle housing body segment wall |
|---|---|
| 501H1 | barbed outer surface of fourth nozzle housing body segment |
| 501K | nozzle housing body axial top aperture |
| 501L | nozzle housing body bottom aperture |
| 501M | nozzle housing body passage |
| 502 | nozzle housing cap |
| 502A1 | first nozzle housing cap end |
| 502A2 | second nozzle housing cap end |
| 502B | nozzle housing cap axis |
| 502C | nozzle housing cap outer wall |
| 502D | nozzle housing cap end wall |
| 502E | nozzle housing cap flange |
| 502E1 | bottom side of nozzle housing cap flange |
| 502E2 | protrusions or bosses on cap flange |
| 502F1 | nozzle housing cap outlet aperture |
| 502F2 | secondary nozzle housing cap aperture |
| 502G1 | nozzle housing cap outlet passage |
| 502G2 | secondary nozzle housing cap passage |
| 502H | nozzle housing cap bottom aperture |
| 502J | nozzle housing cap seating passage |
| 502K | top internal end |
| 502L | bottom edge of secondary nozzle housing cap aperture |
| 502M | top edge of secondary nozzle housing cap aperture |
| 502N | first side edge of secondary nozzle housing cap aperture |
| 502P | second side edge of secondary nozzle housing cap aperture |
| 503 | nozzle housing outer lock ring |
| 503A | radial base portion |
| 503B | axially extending outer wall portion |
| 503C | nozzle housing outer lock ring aperture |
| 503D | internally threaded surface of nozzle housing outer lock ring |
| 510 | spherical body |
| 510A1 | first spherical body aperture |
| 510A2 | second spherical body aperture |
| 510A3 | third spherical body aperture |
| 510B | spherical body outer surface |
| 510C | center of spherical body |
| 510D1 | first spherical body passage axis |
| 510D2 | second spherical body passage axis |
| 510D3 | third spherical body passage axis |
| 510E | interior wall |
| 510F1 | first spherical body passage |
| 510F2 | second spherical body passage |
| 510F3 | third spherical body passage or aiming pin bore |
| 511 | nozzle fluid seal |
| 520 | nozzle assembly fastener |
| 520A | internally threaded surface of nozzle assembly fastener |
| 526 | aiming pin tool |
| 526A | shaft or pin of aiming pin tool |
| 530 | nozzle assembly |
| 540 | interlock features |
| 541 | nozzle housing gap |
| 600 | filler pump |
| 615 | filler tube |
| 620 | filler port fitting |
| 630 | filler tool assembly |
| 635 | bottle of wash fluid |
| 810 | method, receiving a signal |
| 820 | method, transmitting fluid |
| 830 | bottom end of first area |
| 840 | first area |
| 850 | top end of first area |

I claim:

1. A system for cleaning a lens of a camera or image sensor:
comprising a frame configured to be mounted to an exterior surface of a motor vehicle;
further comprising a nozzle housing, secured to the frame and configured to receive fluid;
further comprising a spray directing member forming an arcuate outer shape, positioned within the nozzle housing;
wherein the spray directing member forms a first body passage that defines a fluid duct and a second body passage that defines a nozzle;
wherein the fluid duct and the nozzle are fluidly coupled to each other within the spray directing member, whereby the fluid duct is configured to transfer fluid from the nozzle housing to the nozzle for cleaning the lens;
wherein the spray directing member is configured to be engaged a location spaced apart from the nozzle and fluid duct, to rotate the spray directing member within the nozzle housing, to thereby adjust an aim of the nozzle;
further comprising a fluid container secured to, or integrated with, the frame, wherein the fluid container includes a container wall defining an internal chamber and an aperture that exposes the internal chamber to atmospheric pressure so that, in operation, the internal chamber is configured to remain unpressurized;
further comprising a pump secured to the frame, the pump connected to the fluid container, wherein the pump is configured to pressurize fluid to transfer the fluid from the fluid container to the nozzle; and
further comprising a controller configured for electrical connection to the pump wherein the controller transfers power to operate the pump in response to reception of a control signal by the controller.

2. The system of claim 1 wherein an aiming pin bore, formed within the spray directing member and fluidly separated from the fluid duct, is configured to receive a shaft or pin for engaging the spray directing member to rotate the spray directing member within the nozzle housing, to thereby adjust the aim of the nozzle.

3. The system of claim 2 wherein the spray directing member is a spherical body.

4. The system of claim 3 wherein the aiming pin bore is positioned substantially opposite the nozzle.

5. The system of claim 1 further comprising a power supply that is secured to the frame and connected to the controller, wherein the controller transfers power to the pump that is configured to transfer fluid from the fluid container to the nozzle.

6. The system of claim 1 further comprising:
a receiver that is connected to, or integrated with, the controller, wherein the receiver is configured to receive a remotely generated signal and relay a control signal to the controller which transfers power to the pump, whereby the pump transfers fluid from the fluid container to the nozzle; and
a transmitter that is selectively actuable to transmit the remotely generated signal for reception by the receiver.

7. The system of claim 1 further comprising a sensor that is connected to, or integrated with, the controller, and wherein the sensor is configured to automatically relay a sensor control signal to the controller upon sensing predefined conditions, whereby the controller transfers power to the pump that transfers fluid from the fluid container to the nozzle.

8. The system of claim 1 wherein:
the frame includes a back surface that is configured for being mounted to the vehicle;
the frame includes support features extending away from the back surface and including seating surfaces for positioning a license plate;
the frame is configured for seating the license plate, offset from the back surface, to create a storage volume, the storage volume being the volume of space between the back surface of the frame and the license plate when the license plate is secured to the frame;
the support features offset the license plate from the back surface of the frame so that a bottom of the license plate is further away from the back surface of the frame than a top of the license plate, to thereby define a trapezoidal cross section for the storage volume; and
one or more of the fluid container, the controller, and the pump are disposed within the storage volume of the frame.

9. A system for cleaning a lens of a camera or image sensor, comprising:
a frame including a back surface that is configured for being mounted to a motor vehicle, wherein the frame includes a seating surface defining a first area, the first area including a top end and an opposing bottom end, the seating surface in the first area of the frame being configured for seating a license plate and displaying license plate indicia so that the indicia is displayed between the top end of the first area and the bottom end of the first area; and
a nozzle mounted proximate the bottom end of the first area, and configured to direct fluid upwardly to engage the lens for cleaning the lens, wherein the aim of the nozzle is adjustable.

10. The system of claim 9 further comprising:
a fluid container secured to, or integrated with, the frame, wherein the fluid container includes a container wall defining an internal chamber and an aperture that exposes the internal chamber to atmospheric pressure so that, in operation, the internal chamber is configured to remain unpressurized;
a pump secured to the frame, the pump connected to the fluid container, wherein the pump is configured to pressurize fluid to transfer the fluid from the fluid container to the nozzle; and
a controller configured for electrical connection to the pump wherein the controller transfers power to operate the pump in response to reception of a control signal by the controller.

11. The system of claim 10 further comprising a power supply that is secured to the frame and connected to the controller, wherein the controller transfers power to the pump that is configured to transfer fluid from the fluid container to the nozzle.

12. The system of claim 10 further comprising:
a receiver that is connected to, or integrated with, the controller, wherein the receiver is configured to receive a remotely generated signal and relay a control signal to the controller which transfers power to the pump, whereby the pump transfers fluid from the fluid container to the nozzle; and
a transmitter that is selectively actuable to transmit the remotely generated signal for reception by the receiver.

13. The system of claim 10 further comprising a sensor that is connected to, or integrated with, the controller, and wherein the sensor is configured to automatically relay a sensor control signal to the controller upon sensing predefined conditions, whereby the controller transfers power to the pump that transfers fluid from the fluid container to the nozzle.

14. The system of claim 10, wherein the frame is configured to offset the license plate from the back surface of the frame, thereby defining a storage volume at the first area of the frame between the back surface of the frame and the license plate when the license plate is secured to the frame; and
one or more of the fluid container, the controller, and the pump are disposed within the storage volume of the frame.

15. The system of claim 14, comprising a plurality of support features that offset the license plate from the back surface of the frame so that a bottom of the license plate is further away from the back surface of the frame than a top of the license plate, to thereby define a trapezoidal cross section for the storage volume.

16. The system of claim 14 wherein the frame is configured to position the license plate vertically downward in relation to an original position of the license plate defined by the license plate being mounted directly to license plate mounting apertures of the motor vehicle.

17. A system for cleaning a lens of a camera or image sensor:
comprising a frame including a back surface that is configured for being mounted to a motor vehicle, wherein the frame includes a seating surface defining a first area, the first area including a top end and an opposing bottom end, the seating surface in the first area of the frame being configured for seating a license plate and displaying license plate indicia so that the indicia is displayed between the top end of the first area and the bottom end of the first area;
wherein the frame is configured to offset the license plate from the back surface of the frame, thereby defining a storage volume at the first area of the frame between the back surface of the frame and the license plate when the license plate is secured to the frame;
wherein the frame is configured to offset the license plate from the back surface of the frame so that a bottom of the license plate is further away from the back surface of the frame than a top of the license plate, to thereby define a trapezoidal cross section for the storage volume; and
further comprising a nozzle secured to the frame wherein the nozzle is configured to direct fluid to engage the lens for cleaning the lens.

18. The system of claim 17 wherein the aim of the nozzle is adjustable.

19. The system of claim 18 further comprising:
a fluid container secured to, or integrated with, the frame, wherein the fluid container includes a container wall defining an internal chamber and an aperture that exposes the internal chamber to atmospheric pressure so that, in operation, the internal chamber is configured to remain unpressurized;
a pump secured to the frame, the pump connected to the fluid container, wherein the pump is configured to pressurize fluid to transfer the fluid from the fluid container to the nozzle; and
a controller configured for electrical connection to the pump wherein the controller transfers power to operate the pump in response to reception of a control signal by the controller.

20. The system of claim 19 further comprising:
a receiver that is connected to, or integrated with, the controller, wherein the receiver is configured to receive a remotely generated signal and relay a control signal to the controller which transfers power to the pump, whereby the pump transfers fluid from the fluid container to the nozzle; and
a transmitter that is selectively actuable to transmit the remotely generated signal for reception by the receiver.
